(19) United States
(12) Patent Application Publication
(10) Pub. No.: US 2008/0091050 A1
(43) Pub. Date: Apr. 17, 2008

(54) Process For Producing Phosphonitrilic Acid Ester

(75) Inventors: Kotaro Kuwata, Tokyo (JP); Hideki Date, Tokyo (JP)

Correspondence Address: STAAS & HALSEY LLP, SUITE 700, 1201 NEW YORK AVENUE, N.W., WASHINGTON, DC, 20005, US

(73) Assignee: ASAHI KASEI CHEMICAL CORPORATION, Tokyo (JP)

(21) Appl. No.: 11/795,686

(22) PCT Filed: Jan. 18, 2006
(86) PCT No.: PCT/JP06/00577

§ 371 Date: Jul. 20, 2007

(30) Foreign Application Priority Data
Jan. 21, 2005 (JP) 2005-014778
Feb. 14, 2005 (JP) 2005-035685

(51) Int. Cl. C07F 9/02

(52) U.S. Cl. 568/12

(57) ABSTRACT

<Problem to be Solved> A process for producing a cyclic and/or linear phosphonitrilic acid ester from a cyclic and/or linear phosphonitrile dichloride is provided, wherein the reaction time is shorter and the content of monochloro phosphazenes is very small.

<Solution> When phosphonitrile dichloride is reacted with a metal arylolate and/or a metal alcoholate in the presence of a reaction solvent, a metal arylolate and/or a metal alcoholate composed of at least two different metals having different ionization energies is used and also a specific compound is used as a catalyst.

### TECHNICAL FIELD

The present invention relates to a process for producing a phosphonitrilic acid ester from phosphonitrile dichloride. More specifically, the present invention relates to a process for producing a phosphonitrilic acid ester with reduced color very rapidly by accelerating reaction using a metal arylolate and/or a metal alcoholate composed of at least two different metals having different ionization energies and adding a specific compound as a catalyst when producing a phosphonitrilic acid ester by reacting phosphonitrile dichloride with the metal arylolate and/or metal alcoholate.

### BACKGROUND ART

Phosphonitrilic acid esters are used in a broad range of applications such as additives to plastics and rubber, fertilizers and medicines. Recently, in particular, there is a growing social interest in flame retardancy and nonflammability of plastics with a non-halogen flame retardant. Derivatives of phosphonitrilic acid ester oligomers and phosphonitrilic acid ester polymers not only have excellent flame retardancy but also have vastly superior characteristics such as higher anti-hydrolysis properties and high heat resistance compared to conventional phosphoric acid esters, and have great potential as flame retardant or nonflammable materials. Moreover, since a resin composition to which such derivatives are added has extremely low dielectric constant, they are also useful as a flame retardant for electron materials such as printed wiring board materials and semiconductor encapsulation materials. Accordingly, a process for producing a phosphonitrilic acid ester industrially efficiently is strongly desired.

Of such phosphonitrilic acid esters, those recently particularly attracting attention are cyclic trimers represented by the following formula (7) and cyclic tetramers represented by the following formula (8). 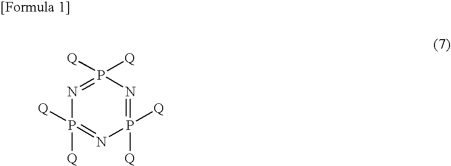
wherein Q represents an aryloxy group or an alkoxy group. 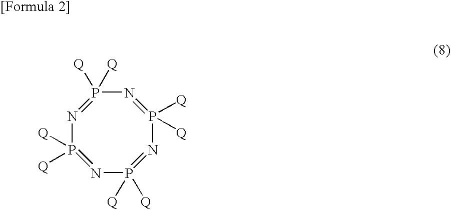
wherein Q represents an aryloxy group or an alkoxy group.

Phosphonitrilic acid ester represented by the following formula (9) contain no chlorine atom (hereinafter referred to as a chloro group) bonded to a phosphorus atom in the structural formula. However, since phosphonitrilic acid ester is generally produced by alkoxylation or aryloxylation of a chloro group bonded to a phosphorus atom, monochloro phosphazenes containing a chloro group remain in a product obtained by aryloxylation and/or alkoxylation reaction as shown in the following formula (10). In production of the above ester, substitution of all chloro groups with aryloxy groups and/or alkoxy groups is difficult and substitution of the last chloro group remaining in the molecule is particularly difficult. 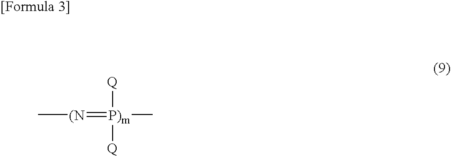
wherein Q represents an aryloxy group or an alkoxy group and m represents an integer of 3 or more. 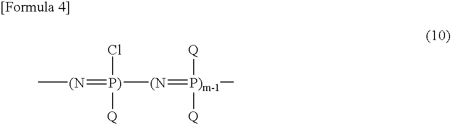
wherein Q represents an aryloxy group or an alkoxy group and m represents an integer of 3 or more.

Remaining chloro groups form hydroxy phosphazenes represented by the following formula (11) due to hydrolysis. As a result, the acid value of the reaction product may be increased or a P—O—P bond may be generated through crosslinking reaction to cause gelation, failing to exhibit excellent properties that phosphonitrilic acid ester has. 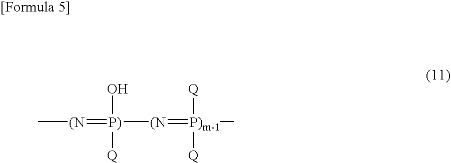
wherein Q represents an aryloxy group or an alkoxy group and m represents an integer of 3 or more.

When, for example, a phosphonitrilic acid ester in which substitution of chloro groups by aryloxy groups and/or alkoxy groups is not completed is added to a resin as a flame retardant, the resin itself is decomposed due to phosphoric acid species derived from P—OH contained in phosphonitrilic acid ester in the case of a polyester resin, in particular, a polycarbonate resin, which is easily decomposed by acid. Consequently, not only thermal properties of the resin composition such as flame retardancy and heat resistance but also various mechanical properties are deteriorated. In the case of resins for uses as electron materials, dielectric properties are also degraded.

The following three processes are known as typical processes for producing a phosphonitrilic acid ester. Specifically, (1) a process in which phosphonitrile dichloride and an alkali metal salt of a hydroxy compound are reacted; (2) a process in which phosphonitrile dichloride and a hydroxy compound are reacted using tertiary amine as a hydrochloric acid trapping agent; and (3) a process in which phosphonitrile dichloride and a hydroxy compound are reacted using a phase transfer catalyst such as quaternary ammonium salt in the presence of a hydrochloric acid trapping agent such as secondary or tertiary amine.

Conventional techniques of producing a phosphonitrilic acid ester are specifically described below.

A process for producing a phosphonitrilic acid ester is widely known, in which alkali metal alcoholate or alkali metal phenolate prepared from alcohol or phenol and alkali hydroxide by azeotropic dehydration is reacted with phosphonitrile dichloride in toluene or xylene as a solvent inert to the reaction (Patent Document 1). However, all chloro groups in phosphonitrile dichloride cannot be substituted, for example, by bulky phenoxy groups in the process. This causes a problem that not only the reaction takes long time but also the content of monochloro phosphazenes is high.

A process is known in which phosphonitrile dichloride, an epoxy compound and an amine compound are reacted using a catalyst such as metal chloride or a solvent according to need (Patent Document 2). While unreacted chloro groups remaining in phosphonitrilic acid ester can be reduced in the process, there is a problem that chlorine atoms tend to remain in the molecule when a glycidyl group in the epoxy compound is ring-opened and reacted with phosphonitrile dichloride. Moreover, since the epoxy compound alone is not sufficiently reactive to phosphonitrile dichloride, an amine compound must be used to complete the reaction, causing a problem that the procedure is complicated.

A process is known in which the amount of remaining chlorine is controlled to 0.01% or less by accelerating nucleophilic reaction by adding a nitrogen-containing linear or cyclic organic compound when cyclic phosphonitrile dichloride is reacted with alkali metal arylolate in toluene as a reaction solvent (Patent Document 3). Although the amount of chlorine remaining in phosphonitrilic acid ester can be certainly reduced in the process, the nitrogen-containing organic compound is needed in a large amount, and a procedure for recovering the nitrogen-containing organic compound from the reaction product or solvent is complicated, making the process industrially disadvantageous.

Also, a process for performing reaction by adding an amine phase transfer catalyst and a pyridine derivative as a hydrogen halide scavenger using dioxane as a reaction solvent is known (Patent Document 4). In this process, not only the reaction takes a long time to complete but also a large amount of an expensive pyridine derivative is needed. While reusing the pyridine derivative is desired, since hydrogen halide salt is formed after completion of the reaction, there is a problem that regeneration steps such as alkali treatment and distillation are complicated.

Further, a process in which toluene is used as a reaction solvent and a quaternary ammonium salt is used as a phase transfer catalyst is known (Patent Documents 5, 6). In the process, a large amount of the quaternary ammonium salt is used and a procedure to recover the salt is complicated. In addition, phosphonitrile dichloride is hydrolyzed more easily since the reaction system is a two-phase system of water and an organic solvent because a large amount of water is used for the reaction. Moreover, when the reaction temperature is increased to enhance the reaction, hydrolysis is more active and phosphoric acid species derived from P—OH is generated, and subsequent gelation occurs more readily due to crosslinking reaction. On the other hand, when the reaction temperature is not increased, the reaction takes a long time to complete.

A process is known in which cyclic phosphonitrile dichloride and an alkali metal arylolate and/or an alkali metal alcoholate are reacted using monochlorobenzene as a reaction solvent while controlling moisture content in the reaction system (Patent Document 7). In the process, the reaction is enhanced by finely dispersing particles of the alkali metal arylolate and/or the alkali metal alcoholate in the reaction solvent by reducing the moisture content when the alkali metal arylolate or alkali metal alcoholate is prepared. However, the reaction is not yet sufficiently enhanced and takes a long time to complete.

A process is known in which alkali metal alcoholate is prepared from alkali metal and alcohol using aliphatic hydrocarbon having 6 to 9 carbon atoms as a reaction solvent and the resulting alkali metal alcoholate is reacted with phosphonitrile dichloride dissolved in monochlorobenzene (Patent Document 8). Although the reaction can be completed in a relatively short time in the process, alkali metal is expensive. Also, since alkali metal is extremely reactive to water and difficult to handle, industrial practice of the process involves problems.

A process is known in which alkali metal arylolate or alkali metal alcoholate is reacted with a phosphonitrile dichloride polymer using dichlorobenzene or trichlorobenzene as a reaction solvent (Patent Document 9). In the process, the moisture content in the reaction system in an aryloxylation and/or alkoxylation reaction is not described. According to the studies of the present inventors, the process has a problem of presenting a slower reaction and significant hydrolysis of phosphonitrile dichloride.

Processes are known in which the moisture content is specified when reacting alkali metal arylolate or alkali metal alcoholate with phosphonitrile dichloride using dichlorobenzene or trichlorobenzene as a reaction solvent (Patent Documents 10, 11, 12). These processes make it possible to prepare phosphonitrilic acid ester which does not contain monochloro phosphazenes very rapidly. However, discolored material is generated by oxidization of phenol when a trace amount of oxygen is present in the reaction system and remains in the product to deteriorate its hue. Therefore, it has been necessary to reduce the amount of oxygen by replacing the atmosphere in the reaction system with inert gas such as nitrogen.

On the other hand, a process in which a reaction solvent is not distilled off from the reaction solution of phosphonitrile dichloride prepared from phosphorus chloride and ammonium chloride and the reaction solution is directly reacted with alcohol and/or phenol is known.

Methods of synthesizing phosphonitrile dichloride used as a main raw material when producing phosphonitrilic acid ester include (1) a method using phosphorus pentachloride, (2) a method using phosphorus trichloride, (3) a method using white phosphorus and (4) a method using phosphorus nitride as a phosphorus source.

Various methods have been studied to prepare phosphonitrile dichloride for a long time. As a typical technique, a method in which phosphorus pentachloride and ammonium chloride are reacted in the presence of a polyvalent metal compound catalyst, and a product containing a cyclic phosphonitrile dichloride oligomer is collected is known (Patent Document 13). Also, a method of preparing cyclic phosphonitrile dichloride by forming fine particles of ammonium chloride by introducing ammonia gas and hydrogen chloride gas into the reaction system and reacting the resulting ammonium chloride with phosphorus chloride is known (Patent Document 14). Moreover, a method of selectively preparing a trimer by reacting phosphorus pentachloride and ammonium chloride using a polyvalent Lewis acidic metal compound and a pyridine derivative such as quinoline as catalysts is known (Patent Document 15).

Phosphonitrile dichloride thus prepared is generally subjected to at least one procedure selected from the isolation steps described below after the step of removing excess ammonium chloride by filtering the reaction slurry containing phosphonitrile dichloride:

1) a procedure of separating, by centrifugation or filtration, a crystalline component (mainly containing a small cyclic phosphazene compound in which m=3 or 4 in the following formula (12)) precipitating when the solvent is evaporated from the reaction solution to concentrate the solution;

2) a procedure of separating a linear phosphazene compound from a cyclic phosphazene compound by adding a hydrocarbon solvent to the component remaining when the solvent is evaporated to concentrate or dry the reaction solution;

3) a procedure of extracting a linear phosphazene compound into the aqueous phase by bringing the reaction solution into contact with water; and

4) a procedure of increasing the content of a cyclic phosphazene compound in which m=3 or 4 in the following formula (12) by purification by recrystallization or sublimation. 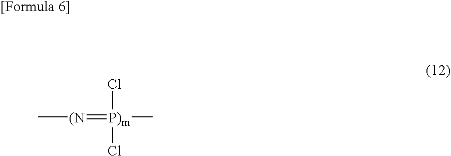
wherein m represents an integer of 3 or more

Phosphonitrile dichloride isolated from the reaction solution or purified after such procedures has been used in the subsequent second step, in other words, as a raw material of alkoxylation or aryloxylation reaction.

As a method of directly reacting phosphonitrile dichloride with alcohol and/or phenol without distilling off a reaction solvent from the reaction solution of phosphonitrile dichloride prepared by the reaction of phosphorus chloride and ammonium chloride, for example, a method of reacting alcohol and cyclic phosphonitrile dichloride using monochlorobenzene as a reaction solvent in the presence of a pyridine derivative is known (Patent Document 16). However, in the method, not only the reaction takes a long time to complete, but also a large amount of an expensive pyridine derivative is needed. Moreover, the method has a disadvantage that recovery and regeneration steps are complicated.

Also, a technique is known in which linear phosphonitrile dichloride is prepared by the reaction of phosphorus pentachloride and ammonium chloride in chlorine-containing unsaturated hydrocarbon, and alcohol is reacted with the resulting reaction solution to prepare polyalkoxyphosphazene (Patent Document 17). The method describes linear chlorinated unsaturated hydrocarbon alone as a reaction solvent. Some of such linear chlorinated unsaturated hydrocarbons is carcinogenic and has a disadvantage for industrial use. In addition, since alkali metal alcoholate is not used and alcohol is directly used in the alkoxylation reaction of phosphonitrile dichloride, the reaction is so slow as to take a long time for completion. Neither does the technique describe moisture content in the reaction system, and according to the studies of the present inventors, the technique also has problems of presenting a slower reaction and ready hydrolysis of phosphonitrile dichloride.

Patent Document 1: U.S. Pat. No. 4,107,108

Patent Document 2: JP-A-51-21000

Patent Document 3: JP-A-2001-2691

Patent Document 4: JP-A-4-13683

Patent Document 5: JP-A-64-87634

Patent Document 6: JP-A-60-155187

Patent Document 7: JP-A-2000-198793

Patent Document 8: U.S. Pat. No. 3,939,228

Patent Document 9: French Patent No. 2700170

Patent Document 10: JP-A-2004-359604

Patent Document 11: JP-A-2004-359617

Patent Document 12: WO2004/108737

Patent Document 13: JP-A-57-3705

Patent Document 14: JP-A-49-47500

Patent Document 15: JP-A-62-39534

Patent Document 16: U.S. Pat. No. 3,794,701

Patent Document 17: Russian Patent No. 385980

### DISCLOSURE OF THE INVENTION

### Problems to be Solved by the Invention

In view of such circumstances, an object of the present invention is to provide a process for producing a cyclic and/or linear phosphonitrilic acid ester from a cyclic and/or linear phosphonitrile dichloride, wherein the reaction time is shorter, the content of monochloro phosphazenes is very small and discoloration is insignificant.

### Means for Solving the Problem

Accordingly, the present inventors have conducted intensive studies on the object of the present invention, i.e., a process in which the reaction time is shorter, the amount of monochloro phosphazenes contained in phosphonitrilic acid ester is reduced and discoloration is insignificant.

As a result, it has been surprisingly found that the reaction is significantly accelerated and rapidly completed, and discoloration is reduced by using, as a raw material, a metal arylolate and/or a metal alcoholate composed of at least two different metals having different ionization energies when producing a phosphonitrilic acid ester by reacting phosphonitrile dichloride with the metal arylolate and/or metal alcoholate. Moreover, it has been found that the reaction is significantly accelerated and rapidly completed by using a specific compound as a reaction catalyst and controlling the moisture content in the reaction system. Furthermore, it has been found that by reacting phosphonitrile dichloride prepared by the reaction of phosphorus chloride and ammonium chloride with a metal arylolate and/or a metal alcoholate without isolating the phosphonitrile dichloride from the reaction slurry, the reaction in the second step is accelerated due to a trace amount of a metal component contained in the reaction solution of the first step containing phosphonitrile dichloride, and thus a phosphonitrilic acid ester in which the content of monochloro phosphazenes is extremely small can be obtained very rapidly, and the present invention has been completed.

Accordingly, the present invention is as follows:

(I) A process for producing a phosphonitrilic acid ester, comprising reacting cyclic and/or linear phosphonitrile dichloride represented by the following formula (1) with at least a compound selected from the group consisting of a metal arylolate represented by the following formula (2), a metal arylolate represented by the following formula (3) and a metal alcoholate represented by the following formula (4) in the presence of a reaction solvent, thereby producing a cyclic and/or linear phosphonitrilic acid ester represented by the following formula (5), characterized in that a metal arylolate and/or a metal alcoholate composed of at least two different metals having different ionization energies is used: 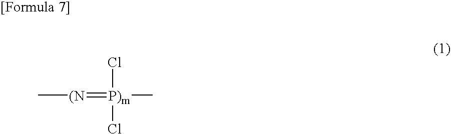
wherein m represents an integer of 3 or more; 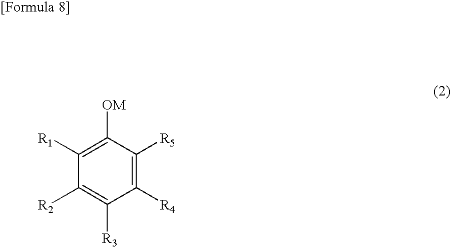
wherein M is an element selected from the group consisting of elements of group IA, IIA, IIIA, IVA, VA, VIA, IIB, IIIB, IVB, VB, VIIB, VIIB and VIII, R₁ to R₅ is a hydrogen atom, an OM group, an aliphatic hydrocarbon group having 1 to 10 carbon atoms or an aromatic hydrocarbon group having 6 to 10 carbon atoms, and R₁ and R₂, R₂ and R₃, R₃ and R₄, and R₄ and R₅ may form a ring; 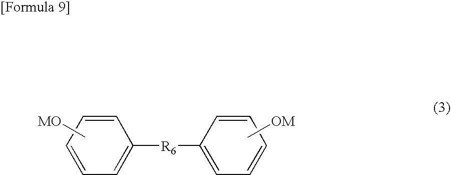
wherein M is an element selected from the group consisting of elements of group IA, IIA, IIIA, IVA, VA, VIA, IIB, IIIB, IVB, VB, VIIB, VIIB and VIII and R₆ is a single bond, an aliphatic hydrocarbon group having 1 to 10 carbon atoms or an aromatic hydrocarbon group having 6 to 10 carbon atoms;
[Formula 10]
R₇O-M (4)
wherein M is an element selected from the group consisting of elements of group IA, IIA, IIIA, IVA, VA, VIA, IIB, IIIB, IVB, VB, VIIB, VIIB and VIII and R₇ is an aliphatic hydrocarbon group having 1 to 10 carbon atoms; and 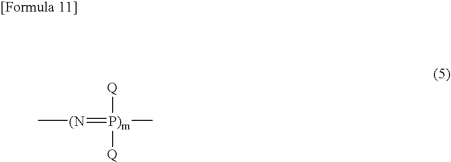
wherein Q represents an aryloxy group or an alkoxy group and m represents an integer of 3 or more.

(II) The process for producing a phosphonitrilic acid ester according to (I), characterized in that a metal arylolate and/or a metal alcoholate composed of at least two different metals having different ionization energies is used and a compound represented by the following formula (6) is used as a catalyst when a cyclic and/or linear phosphonitrilic acid ester is produced:

[Formula 12]
(NH₄)ₚA_{q}Xᵣ (6)
wherein A is an element selected from the group consisting of elements of group IIA, IIIA, IVA, VA, VIA, IIB, IIIB, IVB, VB, VIIB, VIIB and VIII in the long form of periodic table, X represents a halogen atom, p is an integer of 0 to 10, q is an integer of 1 to 10 and r is an integer of 1 to 35.

(III) The process for producing a phosphonitrilic acid ester according to (II), characterized in that the catalyst is represented by p=1 to 3 in the above formula (6).

(IV) The process for producing a phosphonitrilic acid ester according to (II) or (III), characterized in that A in the above formula (6) representing the catalyst is an element selected from the group consisting of Mg, Al, Cr, Co, Cu and Zn.

(V) The process for producing a phosphonitrilic acid ester according to any one of (II) to (IV), characterized in that the catalyst is used in an amount of 10⁻⁵ to 1 mole per mole of phosphonitrile dichloride.

(VI) The process for producing a phosphonitrilic acid ester according to (I), characterized in that a metal arylolate and/or a metal alcoholate composed of at least two different metals having different ionization energies is used and an insoluble component in a reaction slurry obtained in preparation of phosphonitrile dichloride is used as a catalyst to produce a cyclic and/or linear phosphonitrilic acid ester.

(VII) The process for producing a phosphonitrilic acid ester according to (VI), characterized in that the insoluble component in the reaction slurry is included in the reaction slurry formed after phosphorus chloride is reacted with ammonium chloride in the presence of a catalyst using phosphorus chloride and ammonium chloride when phosphonitrile dichloride is prepared.

(VIII) The process for producing a phosphonitrilic acid ester according to any one of (I) to (VII), characterized in that the reaction solvent used for producing a phosphonitrilic acid ester is at least one selected from toluene, xylene, monochlorobenzene, dichlorobenzene and trichlorobenzene.

(IX) The process for producing a phosphonitrilic acid ester according to any one of (I) to (VIII), characterized in that a metal having a higher ionization energy is used in an amount of 50% or less by mole based on the amount of a metal having a lower ionization energy.

(X) The process for producing a phosphonitrilic acid ester according to any one of (I) to (IX), characterized in that metals in the metal arylolate and/or the metal alcoholate are at least two selected from the group consisting of Li, Na, K, Rb, Cs, Mg, Ca, Sr, Ba, Sc, Y, Ti, Zr, Hf, V, Nb, Cr, Mo, Al, Ga, In, Tl, La, Ce, Pr, Nd, Pm, Sm, Eu, Gd, Tb, Dy, Ho, Er, Tm, Yb and Lu.

(XI) The process for producing a phosphonitrilic acid ester according to (X), characterized in that one of the metal arylolate and/or metal alcoholate composed of at least two different metals having different ionization energies is sodium arylolate and/or sodium alcoholate and the other is at least one selected from potassium arylolate, potassium alcoholate, rubidium arylolate, rubidium alcoholate, cesium arylolate and cesium alcoholate.

(XII) The process for producing a phosphonitrilic acid ester according to (XI), characterized in that 0.1 to 2.0 moles of the sodium arylolate and/or sodium alcoholate is used based on 1 mole of chloro groups in phosphonitrile dichloride.

(XIII) The process for producing a phosphonitrilic acid ester according to (XI), characterized in that 0.0001 to 1.0 mole of at least one selected from potassium arylolate, potassium alcoholate, rubidium arylolate, rubidium alcoholate, cesium arylolate and cesium alcoholate is used based on 1 mole of chloro groups in phosphonitrile dichloride.

(XIV) The process for producing a phosphonitrilic acid ester according to (I), wherein the phosphonitrilic acid ester is cyclic and/or linear and represented by the formula (5), characterized by comprising the following two steps:

a first step of preparing phosphonitrile dichloride represented by the formula (1) by reacting phosphorus chloride and ammonium chloride in a halogenated aromatic hydrocarbon as a reaction solvent in the presence of a catalyst; and

a second step of producing the cyclic and/or linear phosphonitrilic acid ester represented by the formula (5) by reacting the phosphonitrile dichloride prepared in the first step with at least one selected from a metal arylolate represented by the formula (2), a metal arylolate represented by the formula (3) and a metal alcoholate represented by the formula (4) without isolating the phosphonitrile dichloride from the reaction slurry in the first step.

(XV) The process for producing a phosphonitrilic acid ester according to (XIV), characterized in that the catalyst used in the first step is at least one selected from metal oxides and metal chlorides.

(XVI) The process for producing a phosphonitrilic acid ester according to (XV), characterized in that the catalyst used in the first step is at least one selected from zinc oxide, magnesium oxide, aluminium oxide, cobalt oxide, copper oxide, zinc chloride, magnesium chloride, aluminum chloride, cobalt chloride, copper chloride and zinc chloride.

(XVII) The process for producing a phosphonitrilic acid ester according to any one of (XIV) to (XVI), characterized in that the halogenated aromatic hydrocarbon is at least one selected from monochlorobenzene, dichlorobenzene and trichlorobenzene.

(XVIII) The process for producing a phosphonitrilic acid ester according to any one of (XIV) to (XVII), characterized in that the phosphonitrile dichloride used in the second step contains 1×10⁻⁶ mole or more of a metal derived from the catalyst from the first step based on 1 mole of phosphonitrile dichloride.

(XIX) A process for continuously producing a phosphonitrilic acid ester, characterized in that when g a cyclic and/or linear phosphonitrilic acid ester represented by the formula (5) is produced by reacting a cyclic and/or linear phosphonitrile dichloride represented by the formula (1) with at least one selected from the group consisting of a metal arylolate represented by the formula (2), a metal arylolate represented by the formula (3) and a metal alcoholate represented by the formula (4), the metal arylolate and/or metal alcoholate comprise at least two different metals having different ionization energies, and phosphonitrile dichloride and the metal arylolate and/or metal alcoholate are continuously fed to a reactor individually or as a premix, and the resulting phosphonitrilic acid ester is continuously discharged to the outside of the reactor from a place different from the feeding port of phosphonitrile dichloride and the metal arylolate and/or metal alcoholate which are raw materials.

(XX) The process for producing a cyclic and/or linear phosphonitrilic acid ester according to any one of (I) to (XIX), characterized in that 0.5 mole or less of water is contained in the reaction system based on 1 mole of phosphonitrile dichloride when producing a cyclic and/or linear phosphonitrilic acid ester from cyclic and/or linear phosphonitrile dichloride.

### ADVANTAGES OF THE INVENTION

The process for producing a phosphonitrilic acid ester of the present invention makes it possible to produce a phosphonitrilic acid ester in which the content of monochloro phosphazenes is extremely small and which is less discolored by using a metal arylolate and/or a metal alcoholate composed of at least two different metals having different ionization energies as raw materials and a specific compound as a reaction catalyst when producing a cyclic and/or linear phosphonitrilic acid ester by reacting cyclic and/or linear phosphonitrile dichloride with the metal arylolate and/or metal alcoholate.

Further, a phosphonitrilic acid ester can be produced very rapidly by reacting phosphonitrile dichloride prepared by reacting phosphorus chloride and ammonium chloride in the presence of a catalyst with a metal arylolate and/or a metal alcoholate without isolating phosphonitrile dichloride from the reaction slurry.

The present invention also makes it possible to shorten the reaction time and reduce the utility cost because the reaction proceeds extremely rapidly. Further, since discoloration of the resulting product is insignificant, the hue when mixed with a resin or the like is good, and thus the step of dediscoloration phosphonitrilic acid ester is not required. Therefore, a phosphonitrilic acid ester can be prepared more inexpensively. Accordingly, the present invention makes it possible to produce industrially useful phosphonitrilic acid ester at a low content of monochloro phosphazenes. As a result, anti-hydrolysis properties and heat resistance of phosphonitrilic acid ester are improved. Moreover, since deterioration of physical properties of a resin composition is suppressed, use of derivatives of phosphonitrilic acid ester oligomers or phosphonitrilic acid ester polymers can be expected in a broad range of applications such as additives for plastics and rubber, fertilizers and medicines.

### BEST MODE FOR CARRYING OUT THE INVENTION

The invention of the present application is described below.

First, the terms used in the present invention are described.

In the present invention, the step of preparing phosphonitrile dichloride which is one of the raw materials, i.e., the step of preparing phosphonitrile dichloride from phosphorus chloride and ammonium chloride is called the first step. The step of producing a phosphonitrilic acid ester from phosphonitrile dichloride and a metal arylolate and/or a metal alcoholate is called the second step. The catalyst used in the first step is called the reaction catalyst of the first step. The solid component present in the reaction slurry prepared in the first step is called an insoluble component. Part of the insoluble component may be included in phosphonitrile dichloride depending on types of solvents used in the first step, the method of solid-liquid separation performed after the first step, or temperature.

The catalyst used in the second step is called the reaction catalyst of the second step.

The present invention has the following characteristics.

[1] A metal arylolate and/or a metal alcoholate composed of at least two different metals having different ionization energies is used as a raw material in the step of producing a phosphonitrilic acid ester.

More preferred characteristics are as follows:

[2] A specific compound is used as a catalyst when producing a phosphonitrilic acid ester from phosphonitrile dichloride and a metal arylolate and/or a metal alcoholate;

[3] An insoluble component generated in the first step is used as a catalyst when producing a phosphonitrilic acid ester from phosphonitrile dichloride and a metal arylolate and/or a metal alcoholate;

[4] Phosphonitrile dichloride is fed to the second step without isolating from the reaction slurry of the first step when producing a phosphonitrilic acid ester; and

[5] Phosphonitrilic acid ester is continuously produced by continuously feeding phosphonitrile dichloride and a metal arylolate and/or a metal alcoholate to the reactor and discharging the resulting phosphonitrilic acid ester to the outside of the reactor from a place different from the feeding port of raw materials.

In the following, the above [1] to [5] are each described.

First, [1] is described.

In the present invention, the reaction between phosphonitrile dichloride and a metal arylolate and/or a metal alcoholate is performed using a metal arylolate and/or a metal alcoholate composed of at least two different metals having different ionization energies. Phenols used for the metal arylolate in the present invention are monovalent phenols and/or divalent phenols in which M in the formulas (2), (3) is a hydrogen atom. Monovalent phenols contain 0 to 5 substituents other than a hydroxyl group and contain an aliphatic hydrocarbon group having 1 to 10 carbon atoms or an aromatic hydrocarbon group having 6 to 10 carbon atoms as a substituent. Divalent phenols contain 0 to 8 substituents other than two hydroxyl groups and contain an aliphatic hydrocarbon group having 1 to 10 carbon atoms or an aromatic hydrocarbon group having 6 to 10 carbon atoms as a substituent. Specific examples of monovalent phenols preferably include phenol, 1-naphthol, 2-naphthol, 4-phenylphenol, o-cresol, m-cresol, p-cresol, o-ethylphenol, m-ethylphenol, p-ethylphenol, o-propylphenol, m-propylphenol, p-propylphenol, o-isopropylphenol, m-isopropylphenol, p-isopropylphenol, o-butylphenol, m-butylphenol, p-butylphenol, o-(2-methylpropyl)phenol, m-(2-methylpropyl)phenol, p-(2-methylpropyl)phenol, o-t-butylphenol, m-t-butylphenol, p-t-butylphenol, o-pentylphenol, m-pentylphenol, p-pentylphenol, o-(2-methylbutyl)phenol, m-(2-methylbutyl)phenol, p-(2-methylbutyl)phenol, o-(3-methylbutyl)phenol, m-(3-methylbutyl)phenol, p-(3-methylbutyl)phenol, o-t-amylphenol, m-t-amylphenol, p-t-amylphenol, 1-hydroxy-2-methylnaphthalene, 1-hydroxy-3-methylnaphthalene, 1-hydroxy-4-methylnaphthalene, 1-hydroxy-5-methylnaphthalene, 1-hydroxy-6-methylnaphthalene, 1-hydroxy-7-methylnaphthalene, 1-hydroxy-8-methylnaphthalene, 2-ethyl-1-hydroxynaphthalene, 3-ethyl-1-hydroxynaphthalene, 4-ethyl-1-hydroxynaphthalene, 5-ethyl-1-hydroxynaphthalene, 6-ethyl-1-hydroxynaphthalene, 7-ethyl-1-hydroxynaphthalene, 8-ethyl-1-hydroxynaphthalene, 2-hydroxy-1-methylnaphthalene, 2-hydroxy-3-methylnaphthalene, 2-hydroxy-4-methylnaphthalene, 2-hydroxy-5-methylnaphthalene, 2-hydroxy-6-methylnaphthalene, 2-hydroxy-7-methylnaphthalene, 2-hydroxy-8-methylnaphthalene, 1-ethyl-2-hydroxynaphthalene, 3-ethyl-2-hydroxynaphthalene, 4-ethyl-2-hydroxynaphthalene, 5-ethyl-2-hydroxynaphthalene, 6-ethyl-2-hydroxynaphthalene, 7-ethyl-2-hydroxynaphthalene, 8-ethyl-2-hydroxynaphthalene, 2-methyl-4-phenylphenol, 2-ethyl-4-phenylphenol, 2,3-xylenol, 2,4-xylenol, 2,5-xylenol, 2,6-xylenol, 3,4-xylenol, 3,5-xylenol, 2-ethyl-6-methylphenol, 3-ethyl-6-methylphenol, 4-ethyl-6-methylphenol, 5-ethyl-6-methylphenol, 2-ethyl-3-methylphenol, 2-ethyl-4-methylphenol, 2-ethyl-5-methylphenol, 3-ethyl-5-methylphenol, 2-methyl-3-n-propylphenol, 2-methyl-4-n-propylphenol, 2-methyl-5-n-propylphenol, 2-methyl-6-n-propylphenol, 3-methyl-2-n-propylphenol, 4-methyl-2-n-propylphenol, 5-methyl-2-n-propylphenol, 3-methyl-4-n-propylphenol, 3-methyl-5-n-propylphenol, 2-methyl-3-isopropylphenol, 2-methyl-4-isopropylphenol, 2-methyl-5-isopropylphenol, 2-methyl-6-isopropylphenol, 3-methyl-2-isopropylphenol, 4-methyl-2-isopropylphenol, 5-methyl-2-isopropylphenol, 3-methyl-4-isopropylphenol, 3-methyl-5-isopropylphenol, 2-butyl-6-methylphenol, 3-n-butyl-6-methylphenol, 4-n-butyl-6-methylphenol, 5-n-butyl-6-methylphenol, 2-n-butyl-3-methylphenol, 2-n-butyl-4-methylphenol, 2-n-butyl-5-methylphenol, 3-n-butyl-4-methylphenol, 3-n-butyl-5-methylphenol, 2-(2-methylpropyl)-6-methylphenol, 2-(2-methylpropyl)-6-methylphenol, 3-(2-methylpropyl)-6-methylphenol, 4-(2-methylpropyl)-6-methylphenol, 5-(2-methylpropyl)-6-methylphenol, 2-(2-methylpropyl)-3-methylphenol, 2-(2-methylpropyl)-4-methylphenol, 2-(2-methylpropyl)-5-methylphenol, 3-(2-methylpropyl)-4-methylphenol, 3-(2-methylpropyl)-5-methylphenol, 2-(3-methylpropyl)-6-methylphenol, 3-(3-methylpropyl)-6-methylphenol, 4-(3-methylpropyl)-6-methylphenol, 5-(3-methylpropyl)-6-methylphenol, 2-(3-methylpropyl)-3-methylphenol, 2-(3-methylpropyl)-4-methylphenol, 2-(3-methylpropyl)-5-methylphenol, 3-(3-methylpropyl)-4-methylphenol, 3-(3-methylpropyl)-5-methylphenol, 2-t-butyl-6-methylphenol, 3-t-butyl-6-methylphenol, 4-t-butyl-6-methylphenol, 5-t-butyl-6-methylphenol, 2-t-butyl-3-methylphenol, 2-t-butyl-4-methylphenol, 2-t-butyl-5-methylphenol, 3-t-butyl-4-methylphenol, 3-t-butyl-5-methylphenol, 2,3-diethylphenol, 2,4-diethylphenol, 2,5-diethylphenol, 2,6-diethylphenol, 3,4-diethylphenol, 2,3-di-n-propylphenol, 2,4-di-n-propylphenol, 2,5-di-n-propylphenol, 2,6-di-n-propylphenol, 3,5-di-n-propylphenol, 2,3-di-isopropylphenol, 2,4-di-isopropylphenol, 2,5-di-isopropylphenol, 2,6-di-isopropylphenol, 3,4-di-isopropylphenol, 3,5-di-isopropylphenol, 2,3-di-t-butylphenol, 2,4-di-t-butylphenol, 2,5-di-t-butylphenol, 2,6-di-t-butylphenol, 3,4-di-t-butylphenol, 3,5-di-t-butylphenol, 2,3-di-t-amylphenol, 2,4-di-t-amylphenol, 2,5-di-t-amylphenol, 2,6-di-t-amylphenol, 3,4-di-t-amylphenol, 3,5-di-t-amylphenol, 1-hydroxy-2,3-dimethylnaphthalene, 1-hydroxy-2,5-dimethylnaphthalene, 1-hydroxy-2,6-dimethylnaphthalene, 1-hydroxy-2,7-dimethylnaphthalene, 2-hydroxy-1,3-dimethylnaphthalene, 2-hydroxy-1,5-dimethylnaphthalene, 2-hydroxy-1,7-dimethylnaphthalene, 2-hydroxy-1,8-dimethylnaphthalene, 2,3-diethyl-1-hydroxynaphthalene, 2,5-diethyl-1-hydroxynaphthalene, 2,6-diethyl-1-hydroxynaphthalene, 2,7-diethyl-1-hydroxynaphthalene, 1,3-diethyl-2-hydroxynaphthalene, 1,5-diethyl-2-hydroxynaphthalene, 1,7-diethyl-2-hydroxynaphthalene, 1,8-diethyl-2-hydroxynaphthalene, 2,6-dimethyl-4-phenylphenol and 2,6-diethyl-4-phenylphenol. Of these, phenol, 1-naphthol, 2-naphthol, 4-phenylphenol, o-cresol, m-cresol, p-cresol, 2,3-xylenol, 2,4-xylenol, 2,5-xylenol, 2,6-xylenol, 3,4-xylenol and 3,5-xylenol are preferred. Preferred examples of divalent phenols include hydroquinone, 2,2-bis(4′-oxyphenyl)propane (bisphenol A), catechol, 1,2-dihydroxynaphthalene, 1,8-dihydroxynaphthalene, 2,3-dihydroxynaphthalene, 3,4-dihydroxynaphthalene and o,o-biphenol.

Alcohols used for the metal alcoholate in the present invention are alcohols in which M in the formula (4) is a hydrogen atom and which contain an aliphatic hydrocarbon group having 1 to 10 carbon atoms. Examples thereof include methanol, ethanol, n-propanol, isopropanol, n-butanol, 2-butanol, t-butanol, n-pentanol, 2-methylbutanol, 3-methylbutanol, 4-methylbutanol, 2,2-dimethylpropanol, 3,3-dimethylpropanol, 3-ethylpropanol, n-hexanol, 2-methylpentanol, 3-methylpentanol, 4-methylpentanol, 5-methylpentanol, 2,2-dimethylbutanol, 2,3-dimethylbutanol, 2,4-dimethylbutanol, 3,3-dimethylbutanol, 3,4-dimethylbutanol, 3-ethylbutanol, 4-ethylbutanol, 2,2,3-trimethylpropanol, 2,3,3-trimethylpropanol, 3-ethyl-2-methylpropanol, 3-isopropylpropanol, n-heptanol and n-octanol.

These phenols and alcohols may be used alone or in combination at any ratio. When using a plurality of phenols or alcohols, the resulting product of course contains two or more types of aryloxy groups or alkoxy groups.

The metal arylolate represented by the formula (2) or (3) and the metal alcoholate represented by the formula (4) used in the present invention are each a salt of phenol or alcohol with an element selected from the group consisting of elements of group IA, IIA, IIIA, IVA, VA, VIA, IIB, IIIB, IVB, VB, VIIB, VIIB and VIII. The metal arylolate and/or metal alcoholate used in the present invention is a salt of at least two metal elements selected from the elements, which have different ionization energies. The element having higher ionization energy is used in a proportion of 50% or less on a molar basis based on the amount of the element having lower ionization energy. A proportion of the element having higher ionization energy of 50% by mole or less is preferred because discoloration of the product, i.e., phosphonitrilic acid ester, is decreased.

The ionization energy in the present invention means minimum energy necessary for removing an electron from a metal element (first ionization energy), which is the quantity of one of the basic physical properties of substances. The unit is eV (electron volt). For example, Li, Na, K, Rb and Cs each have an ionization energy of 5.392, 5.139, 4.341, 4.177 and 3.894 (eV). In the present invention, the reaction in the second step is dramatically improved by using two or more of such metal elements having different ionization energies.

The metal element for a salt used in the present invention is preferably a metal element having an ionization energy of 8.0 eV or less. For example, an element selected from Li, Na, K, Rb, Cs, Mg, Ca, Sr, Ba, Sc, Y, Ti, Zr, Hf, V, Nb, Cr, Mo, Al, Ga, In, Tl, La, Ce, Pr, Nd, Pm, Sm, Eu, Gd, Tb, Dy, Ho, Er, Tm, Yb and Lu is preferred. An element selected from Li, Na, K, Rb, Cs, Mg, Ca, Sr, Ba, Al, Ga, In, Tl, La, Ce, Pr, Nd, Pm, Sm, Eu, Gd, Tb, Dy and Lu is more preferred and an element selected from Li, Na, K, Rb, Cs and Ca is particularly preferred.

The most preferred aspect of the present invention is a process using sodium salt of phenol and/or alcohol as a raw material and using at least one selected from potassium salt, rubidium salt and cesium salt of phenol and/or alcohol.

In the present invention, when reacting phosphonitrile dichloride and a metal arylolate and/or a metal alcoholate, 0.1 to 2.0 moles, preferably 0.5 to 1.5 moles of sodium arylolate and/or sodium alcoholate is used based on 1 mole of chloro groups in phosphonitrile dichloride. 0.0001 to 1.0 mole, preferably 0.001 to 0.5 mole of at least one selected from potassium arylolate, potassium alcoholate, rubidium arylolate, rubidium alcoholate, cesium arylolate and cesium alcoholate is used in combination based on 1 mole of chloro groups in phosphonitrile dichloride. If at least one selected from potassium salt, rubidium salt and cesium salt of phenol and/or alcohol is used in an amount of less than 0.0001 mole based on 1 mole of chloro groups in phosphonitrile dichloride, a combination of potassium salt, rubidium salt and/or cesium salt is difficult to effectively improve the reaction. On the other hand, if the amount is more than 1.0 mole, unreacted metal arylolate or metal alcoholate remains and causes problems because the content of phenol and alcohol in discharged water or waste water is increased.

The method of preparing metal arylolate or metal alcoholate is not particularly limited. For example, metal hydroxide or metal carbonate such as sodium hydroxide, potassium hydroxide, rubidium hydroxide, cesium hydroxide, sodium carbonate, sodium hydrogen carbonate, potassium carbonate, potassium hydrogen carbonate, rubidium carbonate, rubidium hydrogen carbonate, cesium carbonate or cesium hydrogen carbonate is reacted with phenol or alcohol and the resulting water is removed by heating or under reduced pressure to give metal arylolate or metal alcoholate. Alternatively, an organic solvent which forms an azeotropic mixture with the resulting water may be added and the mixture may be azeotropically dehydrated by heating. Also, metal may be directly reacted with phenol or alcohol to give metal arylolate or metal alcoholate.

Phosphonitrile dichloride used as a raw material in [1] to [3] of the present invention may be cyclic or linear. The composition, i.e., the ratio of a cyclic trimer thereof in which m=3 in the formula (12), a cyclic tetramer in which m=4, a cyclic multimer in which m≧5 and a linear phosphazene compound is not particularly limited. A mixture containing each component at any ratio may be used. The method of preparing phosphonitrile dichloride is not particularly limited and phosphonitrile dichloride prepared by any method may be used. For example, phosphonitrile dichloride containing a cyclic phosphazene compound or a linear phosphazene compound prepared from ammonium chloride and phosphorus pentachloride, or from ammonium chloride, phosphorus trichloride and chlorine may be used. Where necessary, cyclic phosphonitrile dichloride from which linear phosphazene compounds are removed by treating phosphonitrile dichloride with a hydrocarbon solvent may be used, or phosphonitrile dichloride in which the content of cyclic trimers and tetramers is increased by purification by recrystallization or sublimation may be used.

The reaction solvent used in [1] to [3] of the present invention is not particularly limited. For example, at least one selected from toluene, ethylbenzene, 1,2-xylene, 1,3-xylene, 1,4-xylene, 1-methyl-2-ethylbenzene, 1-methyl-3-ethylbenzene, 1-methyl-4-ethylbenzene, chloroform, tetrahydrofuran, benzene, dioxane, dimethylformamide, dimethylacetamide, acetonitrile, monochlorobenzene, 1,2-dichlorobenzene, 1,3-dichlorobenzene, 1,4-dichlorobenzene, 1,2,3-trichlorobenzene, 1,2,4-trichlorobenzene and 1,2,5-trichlorobenzene may be used as a solvent. Of these, aromatic hydrocarbons and halogenated hydrocarbons are particularly preferred. For example, toluene, xylene, monochlorobenzene, 1,2-dichlorobenzene, 1,3-dichlorobenzene, 1,4-dichlorobenzene, 1,2,3-trichlorobenzene, 1,2,4-trichlorobenzene and 1,2,5-trichlorobenzene are preferred. Such a solvent may be used alone or in combination at any ratio.

The reaction solvent is used in an amount of preferably 0.1 to 100 parts by mass, more preferably 1 to 20 parts by mass based on 1 part by mass of phosphonitrile dichloride. If the amount of the reaction solvent is less than 0.1 part by mass, the concentration of raw materials in the reaction system is high, making the reaction solution viscous and effective stirring difficult, which disadvantageously results in slowing the reaction. On the other hand, if the amount of the reaction solvent is more than 100 parts by mass, there are economical disadvantages such as increased utility cost and expanded facilities.

Next, [2] is described.

The compound used as a reaction catalyst in the second step of [2] of the present invention is represented by the following formula (17).

[Formula 13]
(NH₄)ₚA_{q}Xᵣ (17)
wherein X represents a halogen atom, p represents an integer of 0 to 10, q represents an integer of 1 to 10 and r represents an integer of 1 to 35.

In the formula, A is an element selected from the group consisting of elements of group IIA, IIIA, IVA, VA, VIA, IIB, IIIB, IVB, VB, VIIB, VIIB and VIII. Examples thereof include Mg, Ca, Sr, Ba, Sc, Y, Ti, Zr, V, Nb, Cr, Mo, W, Mn, Re, Fe, Ru, Os, Co, Rh, Ir, Ni, Pd, Pt, Cu, Ag, Au, Zn, Cd, Hg, Al, Ga, In, Tl, Si, Ge, Sn, Pb, La, Ce, Pr, Nd, Pm, Sm, Eu, Gd, Tb, Dy, Ho, Er, Tm, Yb and Lu. Of these, Mg, Cr, Mn, Fe, Co, Ni, Cu, Zn, Cd, Al, Ga, Si, La, Ce, Pr, Nd, Sm, Gd, Dy, Ho, Er and Yb are preferred, Mg, Al, Co, Cu, Zn and Gd are more preferred, and Mg, Co, Cu and Zn are particularly preferred.

More specifically, the catalyst is preferably MgCl₂, NH₄MgCl₃, AlCl₃, NH₄AlCl₄, (NH₄)₂AlCl₅, (NH₄)₃AlCl₆, CrCl₃, NH₄CrCl₄, (NH₄)₂CrCl₅, (NH₄)₃CrCl₆, MnCl₂, MnCl₃, NH₄MnCl₃, NH₄MnCl₄, (NH₄)₂MnCl₄, (NH₄)₃MnCl₆, (NH₄)₆MnCl₈, FeCl₂, FeCl₃, NH₄FeCl₃, NH₄FeCl₄, (NH₄)₂Fe₂Cl₆, (NH₄)₂FeCl₅, (NH₄)₃FeCl₆, CoCl₂, NH₄CoCl₃, (NH₄)₂CoCl₄, (NH₄)₃CoCl₅, NiCl₂, NH₄NiCl₃, (NH₄)₂NiCl₄, CuCl, CuCl₂, NH₄CuCl₃, (NH₄)₂CuCl₄, ZnCl₂, NH₄ZnCl₃, (NH₄)₂ZnCl₄, (NH₄)₃ZnCl₅, GaCl₃, NH₄GaCl₄, (NH₄)₂GaCl₅, (NH₄)₃GaCl₆, LaCl₃, (NH₄)₂LaCl₅, (NH₄)₃LaCl₆, GdCl₃, NH₄GdCl₄, (NH₄)₂GdCl₅ and (NH₄)₃GdCl₆. Further, MgCl₂, NH₄MgCl₃, CoCl₂, NH₄CoCl₃, (NH₄)₂CoCl₄, (NH₄)₃CoCl₅, CuCl, CuCl₂, NH₄CuCl₃, (NH₄)₂CuCl₄, ZnCl₂, NH₄ZnCl₃, (NH₄)₂ZnCl₄ and (NH₄)₃ZnCl₅ are more preferred. Also, (NH₄)₃CoCl₅, NH₄CuCl₃, (NH₄)₂CuCl₄, NH₄ZnCl₃, (NH₄)₂ZnCl₄ and (NH₄)₃ZnCl₅ in which p=1 to 3 are particularly preferred because the reaction is facilitated.

These catalysts may be used alone or in combination at any ratio. The catalyst is used in an amount of preferably 10⁻⁵ to 1 mole, more preferably 5×10⁻⁵ to 10⁻¹ mole based on 1 mole of phosphonitrile dichloride.

Next, [3] is described.

The insoluble component used as a reaction catalyst in the second step of [3] of the present invention is a solid component present in a reaction slurry after reacting phosphorus chloride and ammonium chloride in the presence of a reaction catalyst in the first step in the reaction for preparing phosphonitrile dichloride using an excess amount of ammonium chloride over phosphorus chloride.

Generally, after completion of the reaction, phosphonitrile dichloride is isolated by removing such an insoluble component and the reaction solvent from the reaction slurry, or further, the content of a cyclic phosphonitrile dichloride oligomer is increased by distillation or recrystallization.

The compound used as a reaction catalyst in the first step is metal oxide or metal chloride. Types of metals include Mg, Ca, Sr, Ba, Sc, Y, Ti, Zr, V, Nb, Cr, Mo, Mn, Fe, Ru, Co, Rh, Ir, Ni, Pd, Pt, Cu, Ag, Au, Zn, Cd, Hg, Al, Ga, In, Tl, Si, Ge, Sn, Pb, La, Ce, Pr, Nd, Pm, Sm, Eu, Gd, Tb, Dy, Ho, Er, Tm, Yb and Lu. Of these, Mg, Cr, Mn, Fe, Co, Ni, Cu, Zn, Cd, Al, Ga, In, Si, La, Ce, Pr, Nd, Sm, Gd, Dy, Ho, Era and Yb are preferred. Of them, zinc oxide, magnesium oxide, aluminum oxide, cobalt oxide, copper oxide, zinc chloride, magnesium chloride, aluminum chloride, cobalt chloride, copper chloride and zinc chloride are preferred, and zinc oxide and zinc chloride are particularly preferred.

These catalysts may be used alone or in combination at any ratio.

The reaction catalyst of the first step is used in an amount of preferably 10⁻⁵ to 1 mole, more preferably 10⁻³ to 10⁻¹ mole based on 1 mole of phosphorus chloride.

The insoluble component refers to a solid component isolated from the reaction slurry. While details of the insoluble component is not known, the component is assumed to be generated from an excess amount of ammonium chloride and a catalyst component used for preparing phosphonitrile dichloride. In some cases, part of the insoluble component is dissolved in a solvent depending on the solvent used in the reaction of the first step or the reaction temperature.

Methods of isolating the insoluble component from the reaction solution are not particularly limited. Conventionally known methods employed for separating solid from liquid, such as filtration under reduced pressure, filtration under pressure, centrifugation or decantation at room temperature or while heating may be performed.

The insoluble component isolated from the reaction slurry may be stored as is or after drying and used when producing a phosphonitrilic acid ester. The method of drying the insoluble component is not particularly limited. For example, methods in which drying is performed for a few hours at 20 to 150° C. using a hot air dryer or a vacuum dryer may be employed. Since the insoluble component contains ammonium chloride as a main component and is hygroscopic, the component is preferably stored in a low humidity atmosphere.

In [2] and [3] of the present invention, preferably the reaction catalyst of the second step is fed to the reaction system after preparing a metal arylolate and/or a metal alcoholate by removing water by azeotropic dehydration. While the method of feeding is not particularly limited, the catalyst may be added to the prepared slurry containing a metal arylolate and/or a metal alcoholate or to a solution of phosphonitrile dichloride dissolved in a reaction solvent. Further, in [2] and [3], pyridine, quinoline and a derivative thereof may be used in combination in addition to the reaction catalyst of the second step as conventionally known. Examples of pyridine derivatives include 2-hydroxypyridine, 3-hydroxypyridine, 4-hydroxypyridine, 2,6-dihydroxypyridine, 3-hydroxy-6-methylpyridine, 2-chloropyridine, 3-chloropyridine, 2,6-dichloropyridine, α-picoline, β-picoline, γ-picoline, lutidine and methyl ethyl pyridine. Examples of quinoline derivatives include 2-methylquinoline, 3-methylquinoline, 4-methylquinoline, 5-methylquinoline, 6-methylquinoline, 7-methylquinoline, 8-methylquinoline, 2-chloroquinoline, 3-chloroquinoline, 4-chloroquinoline, 5-chloroquinoline, 6-chloroquinoline, 2,3-dichloroquinoline, 2-methyl-4-bromoquinoline, 3-chloroisoquinoline and 8-chloroisoquinoline. These may be used alone or in combination at any ratio.

Further, [4] is described.

The most striking characteristic of [4] of the present invention is to feed phosphonitrile dichloride prepared from phosphorus chloride and ammonium chloride in a halogenated aromatic hydrocarbon solvent in the presence of a reaction catalyst of the first step to the second step for the reaction with a metal arylolate and/or a metal alcoholate without isolating phosphonitrile dichloride from the reaction slurry.

Details are described below.

First, the first step of [4] of the present invention is described.

Preferably, the reaction solvent used in the first step of [4], i.e., when preparing phosphonitrile dichloride from phosphorus chloride and ammonium chloride, is halogenated aromatic hydrocarbon. Examples of halogenated aromatic hydrocarbons include monobromobenzene, monochlorobenzene, monofluorobenzene, 1,2-dibromobenzene, 1,3-dibromobenzene, 1,4-dibromobenzene, 1,2-dichlorobenzene, 1,3-dichlorobenzene, 1,4-dichlorobenzene, 1,2-difluorobenzene, 1,3-difluorobenzene, 1,4-difluorobenzene, 2-bromochlorobenzene, 3-bromochlorobenzene, 4-bromochlorobenzene, 2-fluorochlorobenzene, 3-fluorochlorobenzene, 4-fluorochlorobenzene, 2-fluorobromobenzene, 3-fluorobromobenzene, 4-fluorobromobenzene, 1,2,3-tribromobenzene, 1,2,4-tribromobenzene, 1,2,5-tribromobenzene, 1,2,3-trichlorobenzene, 1,2,4-trichlorobenzene, 1,2,5-trichlorobenzene, 1,2,3-trifluorobenzene, 1,2,4-trifluorobenzene, 1,2,5-trifluorobenzene, dibromochlorobenzene, dibromofluorobenzene, dichlorobromobenzene, dichlorofluorobenzene, difluorobromobenzene and difluorochlorobenzene. Of these, monochlorobenzene, 1,2-dichlorobenzene, 1,3-dichlorobenzene, 1,4-dichlorobenzene, 1,2,3-trichlorobenzene, 1,2,4-trichlorobenzene and 1,2,5-trichlorobenzene are preferred, and 1,2-dichlorobenzene, 1,3-dichlorobenzene and 1,4-dichlorobenzene are more preferred.

These halogenated aromatic hydrocarbons may be used alone or in combination at any ratio.

The reaction solvent is used in an amount of preferably 0.1 to 100 parts by mass, more preferably 1 to 20 parts by mass based on 1 part by mass of phosphorus chloride. If the amount of the reaction solvent is less than 0.1 part by mass, the concentration of raw materials in the reaction system is increased and stirring efficiency is reduced, and therefore more cyclic multimers and linear phosphazene compounds may be generated. On the other hand, if the amount of the reaction solvent is more than 100 parts by mass, utility cost may be increased and expansion of facilities may be required.

In [4] of the present invention, the first step is performed in the presence of a catalyst. The compound used as the catalyst is metal oxide or metal chloride. Examples of metals include Mg, Ca, Sr, Ba, Sc, Y, Ti, Zr, V, Nb, Cr, Mo, Mn, Fe, Ru, Co, Rh, Ir, Ni, Pd, Pt, Cu, Ag, Au, Zn, Cd, Hg, Al, Ga, In, Ti, Si, Ge, Sn, Pb, La, Ce, Pr, Nd, Pm, Sm, Eu, Gd, Tb, Dy, Ho, Er, Tm, Yb and Lu. Of these, Mg, Cr, Mn, Fe, Co, Ni, Cu, Zn, Cd, Al, Ga, In, Si, La, Ce, Pr, Nd, Sm, Gd, Dy, Ho, Er and Yb are preferred. Furthermore, of those compounds, zinc oxide, magnesium oxide, aluminum oxide, cobalt oxide, copper oxide, zinc chloride, magnesium chloride, aluminum chloride, cobalt chloride, copper chloride and zinc chloride are preferred, and zinc oxide and zinc chloride are particularly preferred.

These catalysts may be used alone or in combination at any ratio.

The catalyst is used in an amount of preferably 10⁻⁵ to 1 mole, more preferably 10⁻³ to 10⁻¹ mole based on 1 mole of phosphorus chloride. If the amount of the catalyst is less than 10⁻⁵ mole, the reaction is not completed or takes a long time to complete. On the other hand, if the amount of the catalyst is more than 1 mole, the yield is not improved and the advantage of increasing the amount of the catalyst may not be achieved.

In the first step of [4] of the present invention, catalysts which have been conventionally used, for example, metal sulfides such as ZnS, metal hydroxides such as Mg(OH)₂ and Al(OH)₃, organic carboxylic acid metal salts such as Ba(CH₃COO)₂ and Zn[CH₃(CH₂)₁₆COO]₂, perfluoroalkanesulfonic acid metal salts such as Mg(CF₃SO₃)₂ and Zn(CF₃SO₃)₂ and layered silicates such as smectite, kaolin, mica, talc and wollastonite may be used in addition to the above metal oxide or metal chloride.

Further, in addition to the above catalysts, pyridine, quinoline and derivatives thereof may be used in combination as conventionally known. Examples of pyridine derivatives include 2-hydroxypyridine, 3-hydroxypyridine, 4-hydroxypyridine, 2,6-dihydroxypyridine, 3-hydroxy-6-methylpyridine, 2-chloropyridine, 3-chloropyridine, 2,6-dichloropyridine, α-picoline, β-picoline, γ-picoline, lutidine and methyl ethyl pyridine. Examples of quinoline derivatives include 2-methylquinoline, 3-methylquinoline, 4-methylquinoline, 5-methylquinoline, 6-methylquinoline, 7-methylquinoline, 8-methylquinoline, 2-chloroquinoline, 3-chloroquinoline, 4-chloroquinoline, 5-chloroquinoline, 6-chloroquinoline, 2,3-dichloroquinoline, 2-methyl-4-bromoquinoline, 3-chloroisoquinoline and 8-chloroisoquinoline. These may be used alone or in combination at any ratio.

While the amount to be used of pyridine, quinoline and derivatives thereof is not particularly limited, the amount is preferably 10⁻² to 1 mole based on 1 mole of phosphorus chloride.

In the first step of [4] of the present invention, preferably the moisture content in the reaction system is controlled so as to prepare phosphonitrile dichloride at a high yield. The moisture content in the reaction system is preferably 5×10⁻³ mole or less, more preferably 1×10⁻³ mole or less based on 1 mole of phosphorus chloride.

The moisture content in the reaction system in the first step herein described means the content of water contained in the reaction solution when starting the reaction, i.e., the total amount of water contained in raw materials, catalysts, solvents and gas inert to the reaction and water attached to the inside of the reactor.

The method of controlling the moisture content is not particularly limited. For example, to remove water in a solvent, a dehydrating agent inactive to the solvent, e.g., molecular sieves, calcium hydride, metallic sodium, diphosphorus pentoxide or calcium chloride is used to perform dehydration. Further, distillation is performed where necessary. To remove water adsorbed to ammonium chloride, a method of drying under normal pressure or reduced pressure at 50 to 150° C. using a hot air dryer or a vacuum dryer may be employed. To remove water attached to the inside of the reactor, a method in which the inside of the reactor is heated under normal pressure or reduced pressure or a method in which dry air is circulated at room temperature or while heating may be employed.

Preferably, the reaction is performed in a dry atmosphere inert to the reaction, such as nitrogen or argon.

For ammonium chloride used in the first step of [4] of the present invention, commercially available ammonium chloride may be directly used, or such a commercial product may be used after finely pulverizing, or ammonium chloride produced by the reaction of hydrogen chloride and ammonia in the reaction system may be used. To prepare phosphonitrile dichloride at high yield, ammonium chloride having a small particle size is preferably used. Ammonium chloride has an average particle size of preferably 10 μm or less, more preferably 5 μm or less, further preferably 2.5 μm or less.

The method of pulverizing ammonium chloride is not particularly limited, and a ball mill, a stirring mill, a roller mill or a jet mill may be used.

Since ammonium chloride is hygroscopic and becomes more hygroscopic as pulverization proceeds, pulverization becomes difficult or particles may agglomerate again even if pulverization could be performed, failing to achieve the effect of pulverization. Accordingly, ammonium chloride is preferably pulverized in a dry atmosphere that does not contain moisture and also stored in a dry atmosphere after pulverization.

Preferably, ammonium chloride is sufficiently dried before pulverization in view of pulverization properties. While the method of drying is not particularly limited, a method of drying at 50 to 150° C. for 1 to 5 hours using a hot air dryer or a vacuum dryer may be employed. Preferably, the ammonium chloride pulverized in a dry atmosphere as described above is directly fed to the reaction system.

Ammonium chloride is used in an excess amount relative to phosphorus chloride, specifically, preferably 1.0 to 2.0 moles, more preferably 1.05 to 1.5 moles based on 1 mole of phosphorus chloride.

As phosphorus chloride used in the first step of [4] of the present invention, phosphorus pentachloride may be used as is or phosphorus chloride prepared by reacting phosphorus trichloride and chlorine, white phosphorus and chlorine or yellow white phosphorus and chlorine prior to the reaction or in the reaction system may be used. Of these, phosphorus pentachloride and phosphorus chloride prepared by reacting phosphorus trichloride and chlorine are preferred.

The first step of [4] of the present invention is not particularly limited and can be performed by various methods conventionally known as long as the above reaction conditions are satisfied. For example, a method in which ammonium chloride and a catalyst are added to a halogenated aromatic hydrocarbon solvent, and a halogenated aromatic hydrocarbon solution of phosphorus pentachloride is added dropwise thereto while heating and stirring, or a method in which ammonium chloride and a catalyst are added to a reaction solvent and phosphorus trichloride and chlorine or white phosphorus and chlorine are added thereto while heating and stirring may be used.

While the reaction temperature is not particularly limited, the temperature is preferably 100 to 200° C., more preferably 120 to 180° C. If the reaction temperature is lower than 100° C., the reaction does not proceed or may take a long time to complete. If the reaction temperature is higher than 200° C., sublimation of phosphorus chloride is facilitated and the yield of the phosphonitrile dichloride oligomer may be decreased.

In the first step of [4] of the present invention, inert gas such as nitrogen may be circulated or the pressure in the reaction system may be reduced by a vacuum pump or an aspirator so as to remove the resulting hydrogen chloride gas from the reaction system.

The progress of the first step can be observed by monitoring the amount of hydrogen chloride gas produced by the reaction of phosphorus chloride and ammonium chloride. The reaction may be regarded to be finished when hydrogen chloride gas is no longer produced. Stirring may be further continued so as to complete the reaction.

The second step of [4] of the present invention is now described.

The second step of [4] of the present invention, i.e., the reaction between phosphonitrile dichloride and a metal arylolate and/or a metal alcoholate is performed by reacting the phosphonitrile dichloride prepared in the first step with the metal arylolate and/or metal alcoholate described in the above [1] without isolating the phosphonitrile dichloride from the reaction slurry of the first step.

In the second step of [4] of the present invention, a reaction slurry containing phosphonitrile dichloride prepared by the reaction of phosphorus chloride and ammonium chloride in the first step is used. The reaction slurry in the present invention is as described below. The solvent may be distilled off from the reaction slurry or the resultant may be concentrated or dried according to need.

1) A reaction slurry containing phosphonitrile dichloride which is not subjected to any procedure after the first step (hereinafter reaction solution a); and

2) A solution from which excess ammonium chloride is removed by filtering the above reaction slurry containing phosphonitrile dichloride (hereinafter reaction solution b).

In consideration of the reaction speed in the second step and simplification of the process, the reaction solution a from which ammonium chloride is not filtered off or a solution prepared by partly distilling off the solvent from the reaction solution a and concentrating is preferably used.

In [4] of the present invention, components other than excess ammonium chloride and the solvent should not be removed from the reaction slurry after preparing phosphonitrile dichloride.

Also, in [4] of the present invention, phosphonitrile dichloride prepared by the first step is not isolated or purified from the reaction slurry of the first step.

In [4] of the present invention, the first step is followed by one of the procedures below, which are not included in the category of isolation or purification.

[1] A procedure of separating solid from liquid by filtration, centrifugation or decantation of the reaction slurry by heating or at room temperature or by cooling; and

[2] A procedure of distilling off the solvent from the reaction slurry and concentrating or drying.

After preparing phosphonitrile dichloride by the first step, the procedures for isolating phosphonitrile dichloride as described below should not be performed.

[1] a procedure of separating, by centrifugation or filtration, a crystalline component (mainly containing a small cyclic phosphazene compound in which m=3 or 4 in the following formula (12)) precipitating when the solvent is evaporated from the reaction solution to concentrate the solution;

[2] a procedure of separating a linear phosphazene compound from a cyclic phosphazene compound by precipitating the linear phosphazene compound by adding a hydrocarbon solvent to the component remaining when the solvent is evaporated to concentrate or dry the reaction solution;

[3] a procedure of extracting a linear phosphazene compound into the aqueous phase by bringing the reaction solution into contact with water; and

[4] a procedure of increasing the content of a small cyclic phosphazene compound in which m=3 or 4 in the following formula (12) by purification by recrystallization or sublimation. 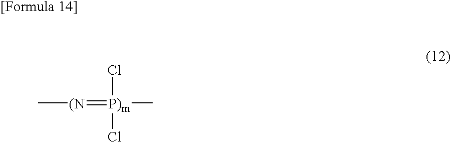
wherein m represents an integer of 3 or more.

Phosphonitrile dichloride used in the second step of [4] of the present invention contains 1×10⁻⁶ mole or more, preferably 1×10⁻⁵ mole or more, more preferably 1×10⁻⁴ mole or more of the metal derived from the reaction catalyst of the first step used in the first step based on 1 mole of phosphonitrile dichloride. If the amount of the metal derived from the reaction catalyst of the first step is less than 1×10⁻⁶ mole, the reaction in the second step disadvantageously takes a long time to complete. Phosphonitrile dichloride may be cyclic or linear. The composition, i.e., the ratio of a cyclic trimer thereof in which m=3 in the formula (2), a cyclic tetramer in which m=4, a cyclic multimer in which m≧5 and a linear phosphazene compound is not particularly limited. A mixture containing each component at any ratio may be used.

The solvent used in the second step of [4] of the present invention is preferably toluene, ethylbenzene, 1,2-xylene, 1,3-xylene, 1,4-xylene, 1-methyl-2-ethylbenzene, 1-methyl-3-ethylbenzene, 1-methyl-4-ethylbenzene, chloroform, tetrahydrofuran, benzene, dioxane, dimethylformamide, dimethylacetamide, acetonitrile, monochlorobenzene, 1,2-dichlorobenzene, 1,3-dichlorobenzene, 1,4-dichlorobenzene, 1,2,3-trichlorobenzene, 1,2,4-trichlorobenzene and 1,2,5-trichlorobenzene. In consideration of easy handling when continuously performing reaction following the first step, monochlorobenzene, 1,2-dichlorobenzene, 1,3-dichlorobenzene, 1,4-dichlorobenzene, 1,2,3-trichlorobenzene, 1,2,4-trichlorobenzene and 1,2,5-trichlorobenzene are more preferred. In consideration of shortening of time for completion of the phenoxylation or alkoxylation reaction, 1,2-dichlorobenzene, 1,3-dichlorobenzene and 1,4-dichlorobenzene are particularly preferred.

The reaction solvent is used in a total amount with the solution after the reaction of the first step of preferably 0.1 to 100 parts by mass, more preferably 1 to 20 parts by mass based on 1 part by mass of phosphonitrile dichloride. An amount of the reaction solvent of less than 0.1 part by mass is not preferred because the concentration of raw materials in the reaction system is high to make the reaction solution viscous, and thus efficient stirring is difficult and the reaction speed is lowered. On the other hand, an amount of the reaction solvent of more than 100 parts by mass is not preferred in economic terms because it involves increase of utility cost and expansion of facilities.

For the metal arylolate represented by the following formula (13) or (14) and metal alcoholate represented by the formula (15) used in [4] of the present invention, the same metal arylolate and metal alcoholate as those represented by the formulas (2), (3) and (4) in [1] may be used. They can be prepared from phenol or alcohol by the same procedure.

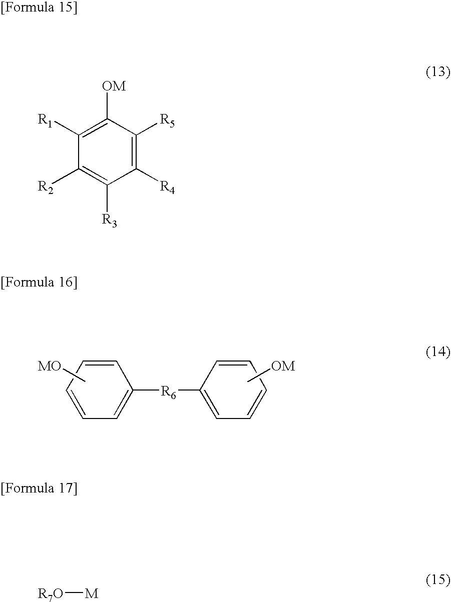

Now, [5] is described.

Typically, phosphonitrilic acid ester has been produced by a batch reaction system. In [5] of the present invention, a continuous reaction can be performed in which raw materials are continuously fed into the reactor and the product is continuously discharged from the reactor utilizing the very fast reaction. The form of the reactor is not particularly limited as long as the reactor has a separate set of a feeding port of raw materials and a delivery port of the product. For example, the following process may be employed: phosphonitrile dichloride and an alkali metal arylolate and/or an alkali metal alcoholate are each fed from a raw material feeding port a and a raw material feeding port b disposed at the lower part of a cylindrical reactor while introducing a solvent or a gas inert to the reaction at a given rate into the cylindrical reactor at 100 to 200° C. to perform the reaction; then, the reaction solution is discharged from a product delivering port c disposed at the upper part of the cylindrical reactor.

To further enhance the reaction of phosphonitrile dichloride and alkali metal arylolate and/or alkali metal alcoholate, the raw materials may be mixed before feeding to the reactor. Also, to improve convection in the reactor, a filler inert to the reaction may be added or bubbling with gas inert to the reaction may be performed. While the feeding rate of raw materials depends on the form of the reactor and other factors, phosphonitrile dichloride is fed to the reactor at a rate of preferably 0.1 to 10⁵ moles/hr per 1 m³ of the reactor.

The same solvents as in [1] to [3] described above are used as reaction solvents in [5].

In the second step of [1], [2], [3], [4] and [5] of the present invention, the moisture content in the reaction system is preferably controlled. The acceptable moisture content in the reaction system is 0.5 mole or less, preferably 0.2 mole or less, more preferably 0.05 mole or less based on 1 mole of phosphonitrile dichloride. When the moisture content in the reaction system is less than 0.5 mole based on 1 mole of phosphonitrile dichloride, no depression of reaction temperature due to azeotropy of water and the reaction solvent occurs and thus the reaction is not slowed, and hydrolysis of phosphonitrile dichloride is suppressed during the reaction so as to prevent generation of monohydroxy phosphazenes.

The moisture content in the reaction system herein described means the content of water contained in the reaction solution when reacting phosphonitrile dichloride and a metal arylolate and/or a metal alcoholate. In other words, the moisture content refers to the total amount of water contained in raw materials, catalysts, solvents and gas inert to the reaction and water attached to the inside of the reactor. The water also includes water generated when preparing a metal alcoholate or a metal arylolate by reacting alcohol or phenol with alkali metal hydroxide for starting alkoxylation reaction or aryloxylation reaction. In the present invention, removal of water produced when preparing a metal alcoholate or a metal arylolate is particularly important. The resulting water is preferably discharged outside the reaction system by azeotropy with the reaction solvent so as to control the moisture content remaining in the reaction system.

The second step of reacting phosphonitrile dichloride and a metal arylolate and/or a metal alcoholate in [1], [2], [3], [4] and [5] of the present invention can be performed by various methods conventionally known. For example, the reaction may be performed by adding dropwise a solution in which phosphonitrile dichloride is dissolved in a reaction solvent to a reaction slurry of a metal arylolate and/or a metal alcoholate prepared by reacting metal hydroxide with phenol and/or alcohol in a reaction solvent and removing water by azeotropic dehydration. Alternatively, the reaction may be performed by suspending a metal arylolate and/or a metal alcoholate previously prepared in a reaction solvent and adding dropwise thereto a solution in which phosphonitrile dichloride is dissolved in a reaction solvent. The reaction can also be performed by adding dropwise the above slurry to a solution in which phosphonitrile dichloride is dissolved in a reaction solvent.

Although the reaction temperature in the second step is not particularly limited, the temperature is preferably 50 to 200° C., more preferably 120 to 185° C. A temperature of lower than 50° C. is not preferred because the reaction does not proceed or takes a long time to complete. A temperature of higher than 200° C. is not preferred because hydrolysis of phosphonitrile dichloride is remarkable and sublimation occurs.

The phenol used in the process for producing a phosphonitrilic acid ester of the present invention may be oxidized by oxygen in air and may generate discolored material. Accordingly, the second step is preferably performed in an inert atmosphere or stream of nitrogen or argon.

In the present invention, the method of collecting the phosphonitrilic acid ester produced after the reaction is not particularly limited. Washing or purification is performed according to purposes of use. For example, phosphonitrilic acid ester may be collected by removing salts generated in the reaction by washing the reaction solution with distilled water or the like and then distilling off the reaction solvent. Also, phosphonitrilic acid ester may be collected by water washing after removing excess phenol or alcohol by washing the reaction solution with alkaline water or distilling the reaction solution under reduced pressure. Moreover, the reaction product collected may be purified by recrystallization from an appropriate solvent. Furthermore, a phosphonitrilic acid ester with a desired composition can be obtained by selecting the solvent in purification by recrystallization.

### EXAMPLES

While the present invention is described in more detail by means of Examples and Comparative Examples below, the present invention is by no means limited thereto.

In Examples and Comparative Examples, the composition of cyclic chlorophosphazene oligomers was determined by an internal standard method based on GPC measurement. When the sum total of composition percentages of a cyclic oligomer is less than 100% in the GPC analysis result, the missing part corresponds to components derived from unreacted phosphorus chloride or linear phosphazene compounds. The end point of aryloxylation and/or alkoxylation reaction was determined by high performance liquid chromatography (hereinafter abbreviated as HPLC). The composition of a phosphonitrilic acid ester, i.e., the ratio of components in which aryloxylation and/or alkoxylation are/is completed, monochloro phosphazenes and monohydroxy phosphazenes, was determined from the ratio of peak areas obtained in ³¹P-NMR. The degree of discoloration of synthesized phosphonitrilic acid esters was determined by UV-Vis measurement.

<GPC Measurement Conditions>

Equipment: HLC-8220 GPC manufactured by TOSOH CORPORATION

Column: TSKgel Super 1000×2 manufactured by TOSOH CORPORATION

TSKgel Super 2000×2

TSKgel Super 3000×1

TSKguard column Super H-L

Column temperature: 40° C.

Eluent: chloroform

Flow rate of eluent: 0.5 ml/min

Internal standard: toluene

<HPLC Measurement Conditions>

Equipment: HPLC 8020 manufactured by TOSOH CORPORATION

Column: Waters Symmetry 300 C18 5 μm 4.9×150 mm×2

Detection wavelength: 254 nm

Column temperature: 40° C.

Eluent: acetonitrile/water=80/20

Flow rate of eluent: 1.0 ml/min

<UV-Vis Measurement>

Equipment: UV-2500PC (manufactured by Shimadzu Corporation)

Solvent: toluene

Concentration of solution: 2.0 wt %

Detection wavelength: 500 nm

For the solvent used in Examples and Comparative Examples, a commercially available guaranteed product (manufactured by Wako Pure Chemical Industries, Ltd.) was used after drying with diphosphorus pentoxide and molecular sieves and distillation. The moisture content in the reaction system was measured using a Karl Fischer moisture content analyzer equipped with a vaporizer.

<Moisture Content Measurement>

Equipment: Moisture Meter Model CA-100 manufactured by Mitsubishi Kasei

Corporation (moisture vaporizer: Model VA-100 manufactured by Mitsubishi Chemical Corporation)

Measurement method: moisture vaporization-coulemetric titration method

A sample was placed on a sample boat and put in VA-100 heated at 120° C. and moisture evaporated by nitrogen flow at 300 ml/min was introduced into a titration cell to measure the moisture content.

Reagent: Aquamicron AX/CXU

Parameter: End Sense 0.1, Delay (VA) 2

<Yield of Phosphonitrilic Acid Ester>

In Examples and Comparative Examples of the present invention, the yield of phosphonitrilic acid ester is defined based on a raw material, phosphonitrile dichloride. More specifically, the yield is calculated by (the number of moles of phosphonitrilic acid ester recovered after reaction)/(the number of moles of phosphonitrile dichloride fed before the reaction)×100.

The recovery rate is considered good when the phosphonitrilic acid ester yield is 98% or more.

<Synthesis of Phosphonitrile Dichloride>

A 1000 ml four-neck flask equipped with a stirrer, a condenser, a dropping funnel and a thermometer was charged with 38.6 g (0.72 mol) of ammonium chloride having an average particle size of 2.1 μm, 0.82 g (10 mmol) of zinc oxide and 340 g of o-dichlorobenzene. Nitrogen flow was introduced into the flask. Part of the reaction solution was collected by a microsyringe and the moisture content was measured. As a result, the moisture content was 2.5×10⁻⁴ mole based on 1 mole of phosphorus pentachloride.

Then, while heating at an oil bath temperature of 177° C., a solution in which 125 g (0.6 mol) of phosphorus pentachloride was dissolved in 340 g of o-dichlorobenzene was added dropwise to the reaction system using a dropping funnel heated to 105° C. over 241 minutes. The feeding rate of phosphorus pentachloride to the reaction system was 0.15 mole/hr per 1 mole of ammonium chloride.

After completion of the dropping, the reaction was continued for 2 hours. During the reaction, the moisture content in the reaction system was less than 2.5×10⁻⁴ mole based on 1 mole of phosphorus pentachloride. After completion of the reaction, unreacted ammonium chloride and the catalyst were removed by filtration to give an insoluble component. The reaction solvent, i.e., the filtrate, was distilled off under reduced pressure, and the solution was concentrated. 1000 g of petroleum ether was added to the slightly yellow viscous liquid obtained by distilling off the solvent and concentration, and then the resultant was filtered to remove impurities. The solvent was distilled off from the collected filtrate under reduced pressure and the resultant was dried to give 69.2 g of a slightly yellow solid (yield: 99.5% based on phosphorus pentachloride). The composition of the reaction product was cyclic trimer: 85.4%, cyclic tetramer: 12.3%>cyclic pentamer: 2.3% in GPC measurement.

<Purification of Phosphonitrile Dichloride by Recrystallization>

30 g of phosphonitrile dichloride synthesized in the above <Synthesis of phosphonitrile dichloride> and 200 ml of toluene were put in a 500 ml round bottom flask and phosphonitrile dichloride was dissolved by refluxing at an oil bath temperature of 110° C. After cooling to room temperature gradually, the solution was allowed to stand at −10° C. for 4 hours. The precipitated crystal was filtered and washed with 50 ml of toluene cooled to −10° C. The crystal was dried by a vacuum drier at 60° C. 21.8 g of crystal was recovered (yield 72.7%). The recovered crystal was found to have a composition of trimer: 99.5% and tetramer: 0.5% in GPC measurement.

<Preparation of (NH₄)₃ZnCl₅>

5.0 g (0.037 mol) of zinc chloride and 5.9 g (0.110 mol) of ammonium chloride were put in a 50 ml round bottom flask and 50 ml of distilled water was added thereto. The mixture was heated at reflux in an oil bath at 110° C. for 1 hour. After cooling to room temperature, water was removed by a rotary evaporator and drying was performed by a vacuum dryer at 110° C. for 5 hours. As a result, 10.7 g of white powder was obtained.

<Preparation of NH₄MgCl₃>

5.0 g (0.052 mol) of magnesium chloride and 2.8 g (0.052 mol) of ammonium chloride were put in a 50 ml round bottom flask and 50 ml of distilled water was added thereto. The mixture was heated at reflux in an oil bath at 110° C. for 1 hour. After cooling to room temperature, water was removed by a rotary evaporator and drying was performed by a vacuum dryer at 110° C. for 5 hours. As a result, 7.5 g of white powder was obtained.

<Preparation of (NH₄)₂CoCl₄>

6.8 g (0.052 mol) of cobalt chloride and 5.6 g (0.104 mol) of ammonium chloride were put in a 50 ml round bottom flask and 50 ml of distilled water was added thereto. The mixture was heated at reflux in an oil bath at 110° C. for 1 hour. After cooling to room temperature, water was removed by a rotary evaporator and drying was performed by a vacuum dryer at 110° C. for 5 hours. As a result, 12.3 g of white powder was obtained.

<Preparation of (NH₄)₂CuCl₄>

7.0 g (0.052 mol) of copper chloride and 5.6 g (0.104 mol) of ammonium chloride were put in a 50 ml round bottom flask and 50 ml of distilled water was added thereto. The mixture was heated at reflux in an oil bath at 110° C. for 1 hour. After cooling to room temperature, water was removed by a rotary evaporator and drying was performed by a vacuum dryer at 110° C. for 5 hours. As a result, 12.5 g of white powder was obtained.

### Example 1

7.05 g (0.075 mol) of phenol, 2.76 g (0.069 mol) of sodium hydroxide, 0.35 g (0.0062 mol) of potassium hydroxide and 30 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.010 mole based on 1 mole of phosphonitrile dichloride. Subsequently, heating was performed at an oil bath temperature of 175° C. The reaction was followed by HPLC and terminated 4 hours after the reaction system reached 170° C. (hereinafter the same). After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.17 g of the reaction product was obtained (yield calculated based on phosphonitrile dichloride: 98.7%). Results of ³¹P-NMR measurement and UV-Vis measurement are shown in Table 1.

### Example 2

7.05 g (0.075 mol) of phenol, 2.76 g (0.069 mol) of sodium hydroxide, 0.93 g (0.0062 mol) of cesium hydroxide and 30 g of o-dichlorobenzene were put in a 200 ml four-neck flask equipped with a stirrer, a condenser, a dropping funnel and a thermometer. Cesium phenoxide and sodium phenoxide were prepared by azeotropic dehydration under nitrogen flow at an oil bath temperature of 190° C. After cooling to room temperature, 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.018 mole based on 1 mole of phosphonitrile dichloride. Subsequently, heating was performed at an oil bath temperature of 175° C. The reaction was followed by HPLC and terminated 3 hours after the reaction system reached a reflux state. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.12 g of the reaction product was obtained (yield calculated based on phosphonitrile dichloride: 98.0%). Results of ³¹P-NMR measurement and UV-Vis measurement are shown in Table 1.

### Example 3

7.05 g (0.075 mol) of phenol, 2.76 g (0.069 mol) of sodium hydroxide, 0.35 g (0.0062 mol) of potassium hydroxide and 20 g of xylene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 150° C. After cooling to room temperature, 0.015 g (0.05 mmol) of (NH₄)₃ZnCl₅ prepared was added thereto and 3.63 g (0.031 mol) of synthesized phosphonitrile dichloride dissolved in 20 g of xylene was added dropwise thereto over 15 minutes. Part of the reaction solution was collected by a microsyringe and the moisture content was measured. As a result, the moisture content was 0.014 mole based on 1 mole of phosphonitrile dichloride. Subsequently, heating was performed at an oil bath temperature of 150° C. The reaction was followed by HPLC and terminated 8 hours after the reaction system reached a reflux state. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.18 g of the reaction product was obtained (yield calculated based on phosphonitrile dichloride: 98.9%). Results of ³¹P-NMR measurement and UV-Vis measurement are shown in Table 1.

### Example 4

7.05 g (0.075 mol) of phenol, 2.76 g (0.069 mol) of sodium hydroxide, 0.35 g (0.0062 mol) of potassium hydroxide and 25 g of monochlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 140° C. After cooling to room temperature, 0.015 g (0.05 mmol) of (NH₄)₃ZnCl₅ prepared was added thereto and 3.63 g (0.031 mol) of synthesized phosphonitrile dichloride dissolved in 25 g of monochlorobenzene was added dropwise thereto over 15 minutes. Part of the reaction solution was collected by a microsyringe and the moisture content was measured. As a result, the moisture content was 0.012 mole based on 1 mole of phosphonitrile dichloride. Subsequently, heating was performed at an oil bath temperature of 140° C. The reaction was followed by HPLC and terminated 5 hours after the reaction system reached a reflux state. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.14 g of the reaction product was obtained (yield calculated based on phosphonitrile dichloride: 98.4%). Results of ³¹P-NMR measurement and UV-Vis measurement are shown in Table 1.

### Example 5

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.015 g (0.05 mmol) of (NH₄)₃ZnCl₅ prepared was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.015 mole based on 1 mole of phosphonitrile dichloride. Subsequently, heating was performed at an oil bath temperature of 150° C. The reaction was followed by HPLC and terminated 3 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.15 g of the reaction product was obtained (yield calculated based on phosphonitrile dichloride: 98.5%). Results of ³¹P-NMR measurement and UV-Vis measurement are shown in Table 1.

### Example 6

7.05 g (0.075 mol) of phenol, 2.76 g (0.069 mol) of sodium hydroxide, 0.93 g (0.0062 mol) of cesium hydroxide and 30 g of o-dichlorobenzene were put in a 200 ml four-neck flask equipped with a stirrer, a condenser, a dropping funnel and a thermometer. Cesium phenoxide and sodium phenoxide were prepared by azeotropic dehydration under nitrogen flow at an oil bath temperature of 190° C. After cooling to room temperature, 0.015 g (0.05 mmol) of (NH₄)₃ZnCl₅ prepared was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.011 mole based on 1 mole of phosphonitrile dichloride. Subsequently, heating was performed at an oil bath temperature of 175° C. The reaction was followed by HPLC and terminated 1 hour after the reaction system reached a reflux state. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.14 g of the reaction product was obtained (yield calculated based on phosphonitrile dichloride: 98.4%). Results of ³¹P-NMR measurement and UV-Vis measurement are shown in Table 1.

### Example 7

6.54 g (0.070 mol) of phenol, 2.76 g (0.069 mol) of sodium hydroxide, 0.0093 g (0.062 mmol) of cesium hydroxide and 30 g of o-dichlorobenzene were put in a 200 ml four-neck flask equipped with a stirrer, a condenser, a dropping funnel and a thermometer. Cesium phenoxide and sodium phenoxide were prepared by azeotropic dehydration under nitrogen flow at an oil bath temperature of 190° C. After cooling to room temperature, 0.015 g (0.05 mmol) of (NH₄)₃ZnCl₅ prepared was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.018 mole based on 1 mole of phosphonitrile dichloride. Subsequently, heating was performed at an oil bath temperature of 175° C. The reaction was followed by HPLC and terminated 3 hours after the reaction system reached a reflux state. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.13 g of the reaction product was obtained (yield calculated based on phosphonitrile dichloride: 98.2%). Results of ³¹P-NMR measurement and UV-Vis measurement are shown in Table 1.

### Example 8

7.05 g (0.075 mol) of phenol, 3.40 g (0.046 mol) of calcium hydroxide, 0.93 g (0.0062 mol) of cesium hydroxide and 30 g of o-dichlorobenzene were put in a 200 ml four-neck flask equipped with a stirrer, a condenser, a dropping funnel and a thermometer. Potassium phenoxide and calcium phenoxide were prepared by azeotropic dehydration under nitrogen flow at an oil bath temperature of 190° C. After cooling to room temperature, 0.015 g (0.05 mmol) of (NH₄)₃ZnCl₅ prepared was added thereto and 3.63 g (0.031 mol) of the synthesized phosphonitrile dichloride trimer dissolved in 25 g of o-dichlorobenzene was added dropwise thereto over 15 minutes. Part of the reaction solution was collected by a microsyringe and the moisture content was measured. As a result, the moisture content was 0.019 mole based on 1 mole of phosphonitrile dichloride. Subsequently, heating was performed at an oil bath temperature of 175° C. The reaction was followed by HPLC and terminated 3 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.09 g of the reaction product was obtained (yield calculated based on phosphonitrile dichloride: 97.6%). Results of ³¹P-NMR measurement and UV-Vis measurement are shown in Table 1.

### Example 9

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.007 g (0.05 mmol) of NH₄MgCl₃ prepared was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.014 mole based on 1 mole of phosphonitrile dichloride. Subsequently, heating was performed at an oil bath temperature of 180° C. The reaction was followed by HPLC and terminated 2 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.13 g of the reaction product was obtained (yield calculated based on phosphonitrile dichloride: 98.2%). Results of ³¹P-NMR measurement and UV-Vis measurement are shown in Table 1.

### Example 10

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.007 g (0.05 mmol) of ZnCl₂ was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.017 mole based on 1 mole of phosphonitrile dichloride. Subsequently, heating was performed at an oil bath temperature of 180° C. The reaction was followed by HPLC and terminated 2 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.16 g of the reaction product was obtained (yield calculated based on phosphonitrile dichloride: 98.6%). Results of ³¹P-NMR measurement and UV-Vis measurement are shown in Table 1.

### Example 11

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.005 g (0.05 mmol) of MgCl₂ was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.019 mole based on 1 mole of phosphonitrile dichloride. Subsequently, heating was performed at an oil bath temperature of 180° C. The reaction was followed by HPLC and terminated 2 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.12 g of the reaction product was obtained (yield calculated based on phosphonitrile dichloride: 98.1%). Results of ³¹P-NMR measurement and UV-Vis measurement are shown in Table 1.

### Example 12

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.007 g (0.05 mmol) of CoCl₂ was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.018 mole based on 1 mole of phosphonitrile dichloride. Subsequently, heating was performed at an oil bath temperature of 180° C. The reaction was followed by HPLC and terminated 2 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.14 g of the reaction product was obtained (yield calculated based on phosphonitrile dichloride: 98.3%). Results of ³¹P-NMR measurement and UV-Vis measurement are shown in Table 1.

### Example 13

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.012 g (0.05 mmol) of (NH₄)₂CoCl₄ prepared was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.016 mole based on 1 mole of phosphonitrile dichloride. Subsequently, heating was performed at an oil bath temperature of 180° C. The reaction was followed by HPLC and terminated 1.5 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.17 g of the reaction product was obtained (yield calculated based on phosphonitrile dichloride: 98.7%). Results of ³¹P-NMR measurement and UV-Vis measurement are shown in Table 1.

### Example 14

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.005 g (0.05 mmol) of CuCl was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.012 mole based on 1 mole of phosphonitrile dichloride. Subsequently, heating was performed at an oil bath temperature of 180° C. The reaction was followed by HPLC and terminated 2 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.13 g of the reaction product was obtained (yield calculated based on phosphonitrile dichloride: 98.2%). Results of ³¹P-NMR measurement and UV-Vis measurement are shown in Table 1.

### Example 15

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.012 g (0.05 mmol) of (NH₄)₂CoCl₄ prepared was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.013 mole based on 1 mole of phosphonitrile dichloride. Subsequently, heating was performed at an oil bath temperature of 180° C. The reaction was followed by HPLC and terminated 2 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.14 g of the reaction product was obtained (yield calculated based on phosphonitrile dichloride: 98.4%). Results of ³¹P-NMR measurement and UV-Vis measurement are shown in Table 1.

### Example 16

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 0.015 g (0.05 mmol) of (NH₄)₃ZnCl₅ prepared was added thereto and 3.63 g (0.031 mol) of phosphonitrile dichloride purified by recrystallization dissolved in 25 g of o-dichlorobenzene was added dropwise thereto over 15 minutes. Part of the reaction solution was collected by a microsyringe and the moisture content was measured. As a result, the moisture content was 0.014 mole based on 1 mole of phosphonitrile dichloride. Subsequently, heating was performed at an oil bath temperature of 180° C. The reaction was followed by HPLC and terminated 2 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.14 g of the reaction product was obtained (yield calculated based on phosphonitrile dichloride: 98.4%). Results of ³¹P-NMR measurement and UV-Vis measurement are shown in Table 1.

### Example 17

7.05 g (0.075 mol) of phenol, 2.76 g (0.069 mol) of sodium hydroxide, 0.35 g (0.0062 mol) of potassium hydroxide and 20 g of xylene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 150° C. After cooling to room temperature, 5.00 mg of the insoluble component prepared in the above <Synthesis of phosphonitrile dichloride> was added thereto and 3.63 g (0.031 mol) of synthesized phosphonitrile dichloride dissolved in 20 g of xylene was added dropwise thereto over 15 minutes. Part of the reaction solution was collected by a microsyringe and the moisture content was measured. As a result, the moisture content was 0.009 mole based on 1 mole of phosphonitrile dichloride. Subsequently, heating was performed at an oil bath temperature of 150° C. The reaction was followed by HPLC and terminated 7 hours after the reaction system reached 140° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.12 g of the reaction product was obtained (yield calculated based on phosphonitrile dichloride: 98.1%). Results of ³¹P-NMR measurement and UV-Vis measurement are shown in Table 1.

### Example 18

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 5.00 mg of the insoluble component prepared in the above <Synthesis of phosphonitrile dichloride> was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.010 mole based on 1 mole of phosphonitrile dichloride. Subsequently, heating was performed at an oil bath temperature of 180° C. The reaction was followed by HPLC and terminated 1.5 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.14 g of the reaction product was obtained (yield calculated based on phosphonitrile dichloride: 98.3%). Results of ³¹P-NMR measurement and UV-Vis measurement are shown in Table 1.

### Example 19

7.05 g (0.075 mol) of phenol, 2.76 g (0.069 mol) of sodium hydroxide, 0.93 g (0.0062 mol) of cesium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 5.00 mg of the insoluble component prepared in the above <Synthesis of phosphonitrile dichloride> was added thereto and 3.63 g (0.031 mol) of synthesized phosphonitrile dichloride dissolved in 25 g of o-dichlorobenzene was added dropwise thereto over 15 minutes. Part of the reaction solution was collected by a microsyringe and the moisture content was measured. As a result, the moisture content was 0.021 mole based on 1 mole of phosphonitrile dichloride. Subsequently, heating was performed at an oil bath temperature of 180° C. The reaction was followed by HPLC and terminated 1 hour after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.12 g of the reaction product was obtained (yield calculated based on phosphonitrile dichloride: 98.1%). Results of ³¹P-NMR measurement and UV-Vis measurement are shown in Table 1.

### Example 20

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, 5.00 mg of the insoluble component prepared in the above <Synthesis of phosphonitrile dichloride> was added thereto and 3.63 g (0.031 mol) of phosphonitrile dichloride purified by recrystallization dissolved in 25 g of o-dichlorobenzene was added dropwise thereto over 15 minutes. Part of the reaction solution was collected by a microsyringe and the moisture content was measured. As a result, the moisture content was 0.013 mole based on 1 mole of phosphonitrile dichloride. Subsequently, heating was performed at an oil bath temperature of 180° C. The reaction was followed by HPLC and terminated 1.5 hours after the reaction system reached 175° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.15 g of the reaction product was obtained (yield calculated based on phosphonitrile dichloride: 98.5%). Results of ³¹P-NMR measurement and UV-Vis measurement are shown in Table 1.

### Example 21

5.11 g (0.054 mol) of phenol, 2.76 g (0.069 mol) of sodium hydroxide, 0.35 g (0.0062 mol) of potassium hydroxide and 25 g of o-dichlorobenzene were put in a 100 ml four-neck flask equipped with a stirrer, a condenser, a dropping funnel, a thermometer and a Dean-Stark trap. Sodium phenoxide and potassium phenoxide were prepared by azeotropic dehydration under nitrogen flow at an oil bath temperature of 190° C. After cooling to room temperature, 2.50 mg of the insoluble component prepared in the above <Synthesis of phosphonitrile dichloride> was added thereto with stirring and 2.50 g (0.022 mol) of synthesized phosphonitrile dichloride dissolved in 15 g of o-dichlorobenzene was added dropwise thereto over 10 minutes. Part of the reaction solution was collected by a microsyringe and the moisture content was measured. As a result, the moisture content was 0.217 mole based on 1 mole of phosphonitrile dichloride. Subsequently, heating and stirring were performed at an oil bath temperature of 180° C. The temperature in the reaction system at that stage was 171° C. The reaction was followed by HPLC and terminated 2.5 hours after the reaction system reached 171° C. After completion of the reaction, the reaction solution was washed with 50 ml of a 10% aqueous potassium hydroxide solution twice and neutralized by diluted hydrochloric acid. When the reaction solution was further washed with 50 ml of distilled water, oil-water separation was poor as a whole. Then, the reaction solvent was distilled off under reduced pressure. As a result, 4.90 g of the reaction product was obtained (yield calculated based on phosphonitrile dichloride: 98.0%). Results of ³¹P-NMR measurement and UV-Vis measurement are shown in Table 1.

### Example 22

### First Step

A 100 ml four-neck flask equipped with a stirrer, a condenser, a dropping funnel and a thermometer was charged with 1.93 g (0.036 mol) of ammonium chloride having an average particle size of 2.1 μm, 0.041 g (0.5 mmol) of zinc oxide and 17 g of o-dichlorobenzene. Nitrogen flow was introduced into the flask. Part of the reaction solution was collected by a microsyringe and the moisture content was measured. As a result, the moisture content was 3.2×10⁻⁴ mole based on 1 mole of phosphorus pentachloride. Subsequently, while heating at an oil bath temperature of 177° C., a solution of 6.25 g (0.03 mol) of phosphorus pentachloride in 17 g of o-dichlorobenzene was added dropwise to the reaction system through the dropping funnel heated to 105° C. After completion of the addition, the reaction was performed for 2 hours. During the reaction, the moisture content in the reaction system was less than 3.2×10⁻⁴ mole based on 1 mole of phosphorus pentachloride. The reaction solution was used in the second step without filtration.

### Second Step

6.77 g (0.072 mol) of phenol, 2.64 g (0.066 mol) of sodium hydroxide, 0.34 g (0.006 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, the reaction solution of the first step was added dropwise thereto over 15 minutes. Part of the reaction solution was collected by a microsyringe and the moisture content was measured. As a result, the moisture content was 0.015 mole based on 1 mole of phosphonitrile dichloride. Subsequently, heating was performed at an oil bath temperature of 180° C. The reaction was followed by HPLC and terminated 1 hour after the temperature of the reaction system reached 175° C. The reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 6.77 g of the reaction product was obtained (yield calculated based on phosphonitrile dichloride: 98.4%). Results of ³¹P-NMR measurement and UV-Vis measurement are shown in Table 1.

### Example 23

### First Step

A 100 ml four-neck flask equipped with a stirrer, a condenser, a dropping funnel and a thermometer was charged with 1.93 g (0.036 mol) of ammonium chloride having an average particle size of 2.1 μm, 0.041 g (0.5 mmol) of zinc oxide and 17 g of o-dichlorobenzene. Nitrogen flow was introduced into the flask. Part of the reaction solution was collected by a microsyringe and the moisture content was measured. As a result, the moisture content was 2.5×10⁻⁴ mole based on 1 mole of phosphorus pentachloride. Subsequently, while heating at an oil bath temperature of 177° C., a solution of 6.25 g (0.03 mol) of phosphorus pentachloride in 17 g of o-dichlorobenzene was added dropwise to the reaction system through the dropping funnel heated to 105° C. After completion of the addition, the reaction was performed for 2 hours. During the reaction, the moisture content in the reaction system was less than 2.5×10⁻⁴ mole based on 1 mole of phosphorus pentachloride. After completion of the reaction, the resultant was cooled to room temperature and unreacted ammonium chloride was removed by filtration under reduced pressure. The amount of zinc contained in the filtrate was 2.4×10⁻⁴ mole based on 1 mole of phosphonitrile dichloride.

### Second Step

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, the reaction solution of the first step was added dropwise thereto over 15 minutes. Part of the reaction solution was collected by a microsyringe and the moisture content was measured. As a result, the moisture content was 0.021 mole based on 1 mole of phosphonitrile dichloride. Subsequently, heating was performed at an oil bath temperature of 180° C. The reaction was followed by HPLC and terminated 1 hour after the reaction system reached 175° C. The reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 6.80 g of the reaction product was obtained (yield calculated based on phosphonitrile dichloride: 98.2%). Results of ³¹P-NMR measurement and UV-Vis measurement are shown in Table 1.

### Example 24

### First Step

A 100 ml four-neck flask equipped with a stirrer, a condenser, a dropping funnel and a thermometer was charged with 1.93 g (0.036 mol) of ammonium chloride having an average particle size of 2.1 μm, 0.041 g (0.5 mmol) of zinc oxide and 17 g of o-dichlorobenzene. Nitrogen flow was introduced into the flask. Part of the reaction solution was collected by a microsyringe and the moisture content was measured. As a result, the moisture content was 1.9×10⁻⁴ mole based on 1 mole of phosphorus pentachloride. Subsequently, while heating at an oil bath temperature of 177° C., a solution of 6.25 g (0.03 mol) of phosphorus pentachloride in 17 g of o-dichlorobenzene was added dropwise to the reaction system through the dropping funnel heated to 105° C. After completion of the addition, the reaction was performed for 2 hours. During the reaction, the moisture content in the reaction system was less than 2.5×10⁻⁴ mole based on 1 mole of phosphorus pentachloride. After completion of the reaction, the resultant was cooled to room temperature and unreacted ammonium chloride was removed by filtration under reduced pressure.

### Second Step

7.05 g (0.075 mol) of phenol, 2.76 g (0.069 mol) of sodium hydroxide, 0.35 g (0.0062 mol) of potassium hydroxide and 25 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. After cooling to room temperature, the reaction solution of the first step was added dropwise thereto over 15 minutes. Part of the reaction solution was collected by a microsyringe and the moisture content was measured. As a result, the moisture content was 0.211 mole based on 1 mole of phosphonitrile dichloride. Subsequently, heating was performed at an oil bath temperature of 180° C. The reaction was followed by HPLC and terminated 3 hours after the temperature of the reaction system reached 171° C. After completion of the reaction, the reaction solution was washed with 50 ml of a 10% aqueous potassium hydroxide solution twice and neutralized by diluted hydrochloric acid. Further, the reaction solution was washed with 50 ml of distilled water. Then, the reaction solvent was distilled off under reduced pressure. As a result, 6.80 g of the reaction product was obtained (yield calculated based on phosphonitrile dichloride: 98.1%). Results of ³¹P-NMR measurement and UV-Vis measurement are shown in Table 1.

### Example 25

While heating a cylindrical reactor measuring 5 mm in inner diameter and 200 mm in length equipped with a stirring blade and a jacket to 175° C., o-dichlorobenzene (moisture content: 10 ppm or less) was fed to the reactor from the lower part to the upper part at a rate of 15 ml/minute. A solution of 3.63 g (0.031 mol) of phosphonitrile dichloride in 50 ml of o-dichlorobenzene and a solution of a mixture of potassium phenoxide and sodium phenoxide, which was previously prepared from 6.54 g (0.070 mol) of phenol, 2.76 g (0.069 mol) of sodium hydroxide and 0.0093 g (0.062 mmol) of cesium hydroxide, in 25 ml of o-dichlorobenzene were each fed to the reactor through raw material feeding ports a, b disposed at the lower part of the reactor at 0.21 ml/minute. The reaction solution was successively recovered from the reactor through a reaction solution collecting port disposed at the upper part of the reactor. The recovered reaction solution was washed with 50 ml of a 10% aqueous potassium hydroxide solution twice and neutralized by diluted hydrochloric acid. Further, the reaction solution was washed with 50 ml of distilled water. Then, the reaction solvent was distilled off under reduced pressure. As a result, 7.11 g of the reaction product was obtained (yield calculated based on phosphonitrile dichloride: 97.9%). Results of ³¹P-NMR measurement and UV-Vis measurement are shown in Table 1.

### Comparative Example 1

7.05 g (0.075 mol) of phenol, 4.20 g (0.075 mol) of potassium hydroxide and 25 g of o-dichlorobenzene were put in a 200 ml four-neck flask equipped with a stirrer, a condenser, a dropping funnel and a thermometer. Potassium phenoxide was prepared by azeotropic dehydration under nitrogen flow at an oil bath temperature of 190° C. After cooling to room temperature, a solution of 3.63 g (0.031 mol) of phosphonitrile dichloride, which was prepared in the above <Synthesis of phosphonitrile dichloride>, in 25 g of o-dichlorobenzene was added dropwise thereto over 15 minutes. Part of the reaction solution was collected by a microsyringe and the moisture content was measured. As a result, the moisture content was 0.019 mole based on 1 mole of phosphonitrile dichloride. Subsequently, heating was performed at an oil bath temperature of 175° C. The reaction was followed by HPLC and terminated 2 hours after the reaction system reached 170° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.15 g of the reaction product was obtained (yield calculated based on phosphonitrile dichloride: 98.5%). Results of ³¹P-NMR measurement and UV-Vis measurement are shown in Table 2.

### Comparative Example 2

7.05 g (0.075 mol) of phenol, 3.00 g (0.075 mol) of sodium hydroxide and 25 g of o-dichlorobenzene were put in a 200 ml four-neck flask equipped with a stirrer, a condenser, a dropping funnel and a thermometer. Sodium phenoxide was prepared by azeotropic dehydration under nitrogen flow at an oil bath temperature of 190° C. After cooling to room temperature, a solution of 3.63 g (0.031 mol) of phosphonitrile dichloride, which was prepared in the above <Synthesis of phosphonitrile dichloride>, in 25 g of o-dichlorobenzene was added dropwise thereto over 15 minutes. Part of the reaction solution was collected by a microsyringe and the moisture content was measured. As a result, the moisture content was 0.017 mole based on 1 mole of phosphonitrile dichloride. Subsequently, heating was performed at an oil bath temperature of 175° C. The reaction was followed by HPLC and terminated 12 hours after the reaction system reached 170° C. The HPLC measurement result showed that monochloro phosphazenes remained. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 7.11 g of the reaction product was obtained (yield calculated based on phosphonitrile dichloride: 97.9%). Results of ³¹P-NMR measurement and UV-Vis measurement are shown in Table 2.

### Comparative Example 3

7.05 g (0.075 mol) of phenol, 2.76 g (0.069 mol) of sodium hydroxide, 0.35 g (0.0062 mol) of potassium hydroxide and 30 g of o-dichlorobenzene were put in a 200 ml four-neck flask equipped with a stirrer, a condenser, a dropping funnel and a thermometer. Sodium phenoxide and potassium phenoxide were prepared by azeotropic dehydration under nitrogen flow at an oil bath temperature of 190° C. A solution of 3.63 g (0.031 mol) of synthesized phosphonitrile dichloride in 25 g of o-dichlorobenzene was added dropwise thereto over 15 minutes. Part of the reaction solution was collected by a microsyringe and the moisture content was measured. However, since the procedure of dehydration was insufficient, the moisture content was 0.501 mole based on 1 mole of phosphonitrile dichloride. Subsequently, heating was performed at an oil bath temperature of 175° C. The reaction was followed by HPLC (hereinafter the same). Since the temperature of the reaction system was not raised above 160° C., the reaction was terminated 9 hours after the temperature reached 160° C. After completion of the reaction, the reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 6.99 g of the reaction product was obtained (yield calculated based on phosphonitrile dichloride: 97.2%). Results of ³¹P-NMR measurement and UV-Vis measurement are shown in Table 2.

### Comparative Example 4

5.11 g (0.054 mol) of phenol, 2.16 g (0.054 mol) of sodium hydroxide and 15 g of xylene were put in a 100 ml four-neck flask equipped with a stirrer, a condenser, a dropping funnel, a thermometer and a Dean-Stark trap. Sodium phenoxide was prepared by azeotropic dehydration under nitrogen flow at an oil bath temperature of 150° C. After cooling to room temperature, a solution of 2.50 g (0.022 mol) of synthesized phosphonitrile dichloride in 15 g of xylene was added dropwise thereto with stirring over 10 minutes. Part of the reaction solution was collected by a microsyringe and the moisture content was measured. As a result, the moisture content was 0.021 mole based on 1 mole of phosphonitrile dichloride. Subsequently, the reaction solution was heated at reflux at an oil bath temperature of 150° C. The temperature in the reaction system at that stage was 141° C. The reaction was followed by HPLC and terminated 12 hours after the onset of reflux. The HPLC measurement result showed that monochloro phosphazenes remained. The reaction solution was washed with 50 ml of a 10% aqueous potassium hydroxide solution twice and neutralized by diluted hydrochloric acid. Further, the reaction solution was washed with 50 ml of distilled water and the reaction solvent was distilled off under reduced pressure. As a result, 4.76 g of the reaction product was obtained (yield calculated based on chlorophosphazene: 95.2%). Results of ³¹P-NMR measurement and UV-Vis measurement are shown in Table 2.

### Comparative Example 5

5.11 g (0.054 mol) of phenol, 0.26 g (1.9 mmol) of zinc chloride and 25 g of dimethylformamide were put in a 100 ml four-neck flask equipped with a stirrer, a condenser, a dropping funnel and a thermometer. With stirring, a solution of 2.50 g (0.022 mol) of synthesized phosphonitrile dichloride in 15 g of dimethylformamide was added dropwise thereto over 10 minutes in nitrogen flow. Part of the reaction solution was collected by a microsyringe and the moisture content was measured. As a result, the moisture content was 0.018 mole based on 1 mole of phosphonitrile dichloride. Subsequently, heating and stirring were performed at an oil bath temperature of 80° C. The reaction was followed by HPLC and terminated 10 hours after the reaction system reached 80° C. After completion of the reaction, the reaction solution was filtered and the reaction solvent was distilled off under reduced pressure. As a result, 4.92 g of the reaction product was obtained (yield calculated based on chlorophosphazene: 98.4%). Results of ³¹P-NMR measurement and UV-V is measurement are shown in Table 2.

### Comparative Example 6

5.11 g (0.054 mol) of phenol, 2.16 g (0.054 mol) of sodium hydroxide and 25 g of o-dichlorobenzene were put in a 100 ml four-neck flask equipped with a stirrer, a condenser, a dropping funnel, a thermometer and a Dean-Stark trap. Sodium phenoxide was prepared by azeotropic dehydration under nitrogen flow at an oil bath temperature of 190° C. After cooling to room temperature, 0.015 g (0.05 mmol) of (NH₄)₃ZnCl₅ prepared was added thereto and a solution of 2.50 g (0.022 mol) of synthesized phosphonitrile dichloride in 15 g of o-dichlorobenzene was added dropwise thereto over 10 minutes. Part of the reaction solution was collected by a microsyringe and the moisture content was measured. As a result, the moisture content was 0.012 mole based on 1 mole of phosphonitrile dichloride. Subsequently, heating and stirring were performed at an oil bath temperature of 180° C. The temperature in the reaction system at that stage was 175° C. The reaction was followed by HPLC and terminated 12 hours after the reaction system reached 175° C. The HPLC measurement result showed that monochloro phosphazenes remained. After completion of the reaction, the reaction solution was washed with 50 ml of a 10% aqueous potassium hydroxide solution twice and neutralized by diluted hydrochloric acid. When the reaction solution was further washed with 50 ml of distilled water, oil-water separation was poor as a whole. Then, the reaction solvent was distilled off under reduced pressure. As a result, 4.71 g of the reaction product was obtained (yield calculated based on chlorophosphazene: 94.2%). Results of ³¹P-NMR measurement and UV-Vis measurement are shown in Table 2.

### Comparative Example 7

1.25 g (0.054 mol) of metallic sodium and 25 g of n-heptane were put in a 100 ml four-neck flask equipped with a stirrer, a condenser, a dropping funnel, a thermometer and a Dean-Stark trap under nitrogen flow and the metallic sodium was dissolved at an oil bath temperature of 120° C. Subsequently, a solution of 5.11 g (0.054 mol) of phenol in 25 g of n-heptane was added thereto in 10 minutes and the byproduct hydrogen gas was removed to prepare sodium phenoxide. After cooling to room temperature, a solution of 2.50 g (0.022 mol) of the synthesized phosphonitrile dichloride trimer in 15 g of o-dichlorobenzene was added dropwise thereto with stirring over 10 minutes. Part of the reaction solution was collected by a microsyringe and the moisture content was measured. As a result, the moisture content was 0.052 mole based on 1 mole of phosphonitrile dichloride. Subsequently, heating and stirring were performed at an oil bath temperature of 150° C. The reaction was followed by HPLC and terminated 12 hours after the onset of reflux. The HPLC measurement result showed that monochloro phosphazenes remained. After completion of the reaction, the reaction solution was washed with 50 ml of a 10% aqueous potassium hydroxide solution twice and neutralized by diluted hydrochloric acid. When the reaction solution was further washed with 50 ml of distilled water, oil-water separation was poor as a whole. Then, the reaction solvent was distilled off under reduced pressure. As a result, 4.66 g of the reaction product was obtained (yield calculated based on phosphonitrile dichloride: 93.2%). Results of ³¹P-NMR measurement and UV-Vis measurement are shown in Table 2.

### Comparative Example 8

5.11 g (0.054 mol) of phenol, 3.00 g (0.054 mol) of potassium hydroxide, 1.05 g (3.25×10⁻³ mol) of tetra-n-butylammonium bromide and 12 g of distilled water were put in a 100 ml four-neck flask equipped with a stirrer, a condenser, a dropping funnel and a thermometer. With stirring, a solution of 2.50 g (0.022 mol) of synthesized phosphonitrile dichloride in 15 g of o-dichlorobenzene was added dropwise thereto over 10 minutes in nitrogen flow. Subsequently, heating and stirring were performed at an oil bath temperature of 150° C. The reaction was followed by HPLC and terminated 12 hours after the reaction system reached a reflux state. The HPLC measurement result showed that monochloro phosphazenes remained. After completion of the reaction, the reaction solution was washed with 50 ml of a 10% aqueous potassium hydroxide solution twice and neutralized by diluted hydrochloric acid. When the reaction solution was further washed with 50 ml of distilled water, oil-water separation was poor as a whole. Then, the reaction solvent was distilled off under reduced pressure. As a result, 3.40 g of the reaction product was obtained (yield calculated based on phosphonitrile dichloride: 67.9%). Results of ³¹P-NMR measurement and UV-Vis measurement are shown in Table 2.

### Comparative Example 9

A 100 ml four-neck flask equipped with a stirrer, a condenser, a dropping funnel and a thermometer was charged with 5.11 g (0.054 mol) of phenol, 8.22 g (0.081 mol) of triethylamine and 0.35 g (0.003 mol) 4-trimethylaminopyridine. With stirring, a solution of 2.50 g (0.022 mol) of synthesized phosphonitrile dichloride in 15 g of o-dichlorobenzene was added dropwise thereto over 20 minutes under nitrogen flow and ice cooling. Subsequently, stirring was performed at a reaction system temperature of 30° C. in a water bath. The reaction was followed by HPLC and terminated 12 hours after the onset of reflux. The HPLC measurement result showed that monochloro phosphazenes remained. After completion of the reaction, the reaction solution was washed with 50 ml of a 10% aqueous potassium hydroxide solution twice and neutralized by diluted hydrochloric acid. When the reaction solution was further washed with 50 ml of distilled water, oil-water separation was poor as a whole. Then, the reaction solvent was distilled off under reduced pressure. As a result, 4.69 g of the reaction product was obtained (yield calculated based on phosphonitrile dichloride: 93.8%). Results of ³¹P-NMR measurement and UV-Vis measurement are shown in Table 2.

### Comparative Example 10

### First Step

A 100 ml four-neck flask equipped with a stirrer, a condenser, a dropping funnel and a thermometer was charged with 1.93 g (0.036 mol) of ammonium chloride having an average particle size of 2.1 μm, 0.041 g (0.5 mmol) of zinc oxide and 17 g of o-dichlorobenzene. Nitrogen flow was introduced into the flask. Part of the reaction solution was collected by a microsyringe and the moisture content was measured. As a result, the moisture content was 1.9×10⁻⁴ mole based on 1 mole of phosphorus pentachloride. Subsequently, while heating at an oil bath temperature of 177° C., a solution of 6.25 g (0.03 mol) of phosphorus pentachloride in 17 g of o-dichlorobenzene was added dropwise to the reaction system through the dropping funnel heated to 105° C. After completion of the addition, the reaction was performed for 2 hours. During the reaction, the moisture content in the reaction system was less than 2.5×10⁻⁴ mole based on 1 mole of phosphorus pentachloride. After completion of the reaction, the resultant was cooled to room temperature and unreacted ammonium chloride was removed by filtration under reduced pressure and the resulting reaction solution was put in a 100 ml separatory funnel. 50 ml of distilled water was added thereto and the mixture in the separatory funnel was sufficiently shaken at room temperature and allowed to stand for a while to separate oil from water. After separating the dichlorobenzene phase, magnesium sulfate was added thereto and the mixture was stirred for 30 minutes. After removing magnesium sulfate by filtration, molecular sieve 4 A was added. The resultant was left overnight and then the molecular sieve 4 A was removed by filtration. The amount of zinc in the filtrate was 5.2×10⁻⁷ mole based on 1 mole of phosphonitrile dichloride.

### Second Step

6.77 g (0.072 mol) of phenol, 2.88 g (0.072 mol) of sodium hydroxide and 25 g of o-dichlorobenzene were put in a 200 ml four-neck flask equipped with a stirrer, a condenser, a dropping funnel and a thermometer. Potassium phenoxide was prepared by azeotropic dehydration under nitrogen flow at an oil bath temperature of 190° C. After cooling to room temperature, the o-dichlorobenzene solution containing phosphonitrile dichloride synthesized in the first step was added dropwise thereto over 20 minutes. Part of the reaction solution was collected by a microsyringe and the moisture content was measured. As a result, the moisture content was 0.025 mole based on 1 mole of phosphonitrile dichloride. Subsequently, heating was performed at an oil bath temperature of 180° C. The reaction was followed by HPLC and terminated 12 hours after the temperature of the reaction system reached 170° C. The HPLC measurement result showed that monochloro phosphazenes remained. After completion of the reaction, the reaction solution was washed with 50 ml of a 10% aqueous potassium hydroxide solution twice and neutralized by diluted hydrochloric acid. Further, the reaction solution was washed with 50 ml of distilled water. As a result, 6.59 g of the reaction product was obtained (yield calculated based on phosphonitrile dichloride: 94.7%). Results of ³¹P-NMR measurement and UV-Vis measurement are shown in Table 2.

TABLE 1

| | | | | | Moisture | | | | Composition of product | |
|---|---|---|---|---|---|---|---|---|---|---|
| | | Phenol metal salt | | | content in | | | Degree | (%)³⁾ | |
| | | (mol eq. vs —Cl) | | | reaction | | | of | Completely | |
| | | | K/Cs | | system | Yield | Reaction | discol- | substituted | Monochloro |
| Ex. | Solvent | Na salt⁴⁾ | salt⁴⁾ | Catalyst | (mol)¹⁾ | (%)²⁾ | time (hrs) | oration | phosphazene | phosphazene |
| 1 | o-dichlorobenzene | 1.10 | 0.10 | none | 0.010 | 98.7 | 4 | 0.031 | 100.0 | 0.0 |
| 2 | o-dichlorobenzene | 1.10 | 0.10 | none | 0.018 | 98.0 | 3 | 0.024 | 100.0 | 0.0 |
| 3 | xylene | 1.10 | 0.10 | none | 0.014 | 98.9 | 8 | 0.022 | 100.0 | 0.0 |
| 4 | monochlorobenzene | 1.10 | 0.10 | (NH₄)₃ZnCl₅ | 0.012 | 98.4 | 5 | 0.026 | 100.0 | 0.0 |
| 5 | o-dichlorobenzene | 1.10 | 0.10 | (NH₄)₃ZnCl₅ | 6.015 | 98.5 | 3 | 0.026 | 100.0 | 0.0 |
| 6 | o-dichlorobenzene | 1.10 | 0.10 | (NH₄)₃ZnCl₅ | 0.011 | 98.4 | 1 | 0.025 | 100.0 | 0.0 |
| 7 | o-dichlorobenzene | 1.10 | 0.001 | (NH₄)₃ZnCl₅ | 0.018 | 98.2 | 3 | 0.027 | 100.0 | 0.0 |
| 8 | o-dichlorobenzene | 1.10 | 0.01 | (NH₄)₃ZnCl₅ | 0.019 | 97.6 | 3 | 0.028 | 100.0 | 0.0 |
| 9 | o-dichlorobenzene | 1.10 | 0.10 | NH₄MgCl₃ | 0.014 | 98.2 | 2 | 0.031 | 100.0 | 0.0 |
| 10 | o-dichlorobenzene | 1.10 | 0.10 | ZnCl₂ | 0.017 | 98.6 | 2 | 0.032 | 100.0 | 0.0 |
| 11 | o-dichlorobenzene | 1.10 | 0.10 | MgCl₂ | 0.019 | 98.1 | 2 | 0.028 | 100.0 | 0.0 |
| 12 | o-dichlorobenzene | 1.10 | 0.10 | CoCl₂ | 0.018 | 98.3 | 2 | 0.026 | 100.0 | 0.0 |
| 13 | o-dichlorobenzene | 1.10 | 0.10 | (NH₄)₂CoCl₄ | 0.016 | 98.7 | 1.5 | 0.024 | 100.0 | 0.0 |
| 14 | o-dichlorobenzene | 1.10 | 0.10 | CuCl | 0.012 | 98.2 | 2 | 0.031 | 100.0 | 0.0 |
| 15 | o-dichlorobenzene | 1.10 | 0.10 | (NH₄)₂CuCl₄ | 0.013 | 98.4 | 2 | 0.033 | 100.0 | 0.0 |
| 16 | o-dichlorobenzene | 1.10 | 0.10 | (NH₄)₃ZnCl₅ | 0.014 | 98.4 | 2 | 0.028 | 100.0 | 0.0 |
| 17 | xylene | 1.10 | 0.10 | Residue after filtration | 0.009 | 98.1 | 7 | 0.021 | 100.0 | 0.0 |
| 18 | o-dichlorobenzene | 1.10 | 0.10 | Residue after filtration | 0.010 | 98.3 | 1.5 | 0.025 | 100.0 | 0.0 |
| 19 | o-dichlorobenzene | 1.10 | 0.10 | Residue after filtration | 0.021 | 98.1 | 1 | 0.026 | 100.0 | 0.0 |
| 20 | o-dichlorobenzene | 1.10 | 0.10 | Residue after filtration | 0.013 | 98.5 | 1.5 | 0.023 | 100.0 | 0.0 |
| 21 | o-dichlorobenzene | 1.10 | 0.10 | Residue after filtration | 0.217 | 98.0 | 2.5 | 0.031 | 100.0 | 0.0 |
| 22 | o-dichlorobenzene | 1.10 | 0.10 | Continuous reaction | 0.015 | 98.4 | 1 | 0.029 | 100.0 | 0.0 |
| | | | | (without filtration) | | | | | | |
| 23 | o-dichlorobenzene | 1.10 | 0.10 | Continuous reaction | 0.021 | 98.2 | 1 | 0.027 | 100.0 | 0.0 |
| | | | | (with filtration) | | | | | | |
| 24 | o-dichlorobenzene | 1.10 | 0.10 | Continuous reaction | 0.211 | 98.1 | 3 | 0.030 | 100.0 | 0.0 |
| | | | | (with filtration) | | | | | | |
| 25 | o-dichlorobenzene | 1.10 | 0.10 | none | — | 97.9 | 4 | 0.028 | 100.0 | 0.0 |

¹⁾Number of moles of water based on 1 mole of phosphonitrile dichloride
²⁾Yield calculated based on phosphonitrile dichloride
³⁾Determined from ratio of peak areas obtained in ³¹P-NMR (Composition percentage of 0.0% means that no peak was found in NMR measurement)
⁴⁾Figures for Na salt and K/Cs salt in Examples 22 to 24 represent amount charged when assuming yield of phosphonitrile dichloride in first step to be 100%.

TABLE 2

| | | | | | Moisture | | | | Composition of product | |
|---|---|---|---|---|---|---|---|---|---|---|
| | | phenol metal salt | | | content in | | | Degree | (%)³⁾ | |
| | | (mol eq. vs —Cl) | | | reaction | | | of | Completely | |
| Comp. | | | K/Cs | | system | Yield | Reaction | discol- | substituted | Monochloro |
| Ex. | Solvent | Na salt⁴⁾ | salt⁴⁾ | Catalyst | (mol)¹⁾ | (%)²⁾ | time (hrs) | oration | phosphazene | phosphazene |
| 1 | o- | | 1.20 | not added | 0.019 | 98.5 | 2 | 0.085 | 100 | 0.0 |
| | dichlorobenzene | | | | | | | | | |
| 2 | o- | 1.20 | | not added | 0.017 | 97.9 | >12 | 0.031 | 91.3 | 8.7 |
| | dichlorobenzene | | | | | | | | | |
| 3 | o- | 1.10 | 0.01 | not added | 0.501 | 97.2 | 9 | 0.054 | 99.7 | 0.3 |
| | dichlorobenzene | | | | | | | | | |
| 4 | xylene | 1.20 | | not added | 0.021 | 95.2 | >12 | 0.039 | 82.1 | 17.9 |
| 5 | dimethylformamide | 1.20 | | zinc chloride | 0.018 | 98.4 | 10 | 0.029 | 99.7 | 0.3 |
| 6 | o- | 1.20 | | (NH₄)₃ZnCl₅ | 0.012 | 94.2 | >12 | 0.032 | 98.2 | 1.8 |
| | dichlorobenzene | | | | | | | | | |
| 7 | o- | 1.20 | | not added | 0.052 | 93.2 | >12 | 0.037 | 89.3 | 10.7 |
| | dichlorobenzene/ | | | | | | | | | |
| | n-heptane | | | | | | | | | |
| 8 | o- | 1.20 | | tetrabutyl- | not | 67.9 | >12 | 0.029 | 58.8 | 41.2 |
| | dichlorobenzene | | | ammonium | measured | | | | | |
| | | | | bromide | | | | | | |
| 9 | o- | | 1.20 | 4- | 0.018 | 93.8 | >12 | 0.055 | 99.5 | 0.5 |
| | dichlorobenzene | | | trimethyl- | | | | | | |
| | | | | aminopyridine/ | | | | | | |
| | | | | triethylamine | | | | | | |
| 10 | o- | 1.20 | | continuous | 0.025 | 94.7 | >12 | 0.036 | 93.2 | 6.8 |
| | dichlorobenzene | | | reaction | | | | | | |
| | | | | (treated | | | | | | |
| | | | | with water) | | | | | | |

¹⁾Number of moles of water based on 1 mole of phosphonitrile dichloride
²⁾Yield calculated based on phosphonitrile dichloride
³⁾Determined from ratio of peak areas obtained in ³¹P-NMR (Composition percentage of 0.0% means that no peak was found in NMR measurement)
⁴⁾Figure for Na salt in Comparative Example 9 represents amount charged when assuming yield of phosphonitrile dichloride in first step to be 100%. (0.0% NMR)

As is evident from comparison between Examples (Table 1) and Comparative Examples (Table 2), when sodium arylolate and/or sodium alcoholate is used and at least one selected from potassium arylolate, potassium alcoholate, cesium arylolate and cesium alcoholate is used together therewith, the reaction is completed very rapidly and phosphonitrilic acid ester containing no monochloro phosphazene can be prepared. In addition, when the catalyst according to the present invention is also used, or the reaction solution of the first step is directly subjected to the second step, the reaction is completed even more rapidly. On the contrary, when potassium salt or cesium salt is not used together therewith, the catalyst according to the present invention is not used or the reaction solution of the first step is not directly used, the reaction takes a long time to complete and monochloro phosphazenes are included. In addition, a single use of a potassium salt makes the reaction proceed very rapidly, but the resulting product is slightly discolored. Moreover, when controlling the moisture content in the reaction system, the reaction is not slowed and generation of monohydroxy phosphazenes is suppressed because hydrolysis of phosphonitrile dichloride is suppressed.

### INDUSTRIAL APPLICABILITY

The process for producing a phosphonitrilic acid ester of the present invention makes it possible to produce a phosphonitrilic acid ester in which the content of monochloro phosphazenes is very small and which is less discolored in a very short time. Since the reaction time is shortened, utility costs can be reduced and phosphonitrilic acid ester can be produced at lower cost. In this way, the present invention makes it possible to produce an industrially useful phosphonitrilic acid ester at a low monochloro phosphazene content. Furthermore, the anti-hydrolysis properties and heat resistance of phosphonitrilic acid ester are improved and deterioration of physical properties of a resin composition thereof is suppressed. Accordingly, use of derivatives of phosphonitrilic acid ester oligomers or phosphonitrilic acid ester polymers can be expected in a broad range of applications such as additives for plastics and rubber, fertilizers and medicines.

1. A process for producing a phosphonitrilic acid ester, comprising reacting a cyclic and/or linear phosphonitrile dichloride represented by the following formula (1) with at least one compound selected from the group consisting of a metal arylolate represented by the following formula (2), a metal arylolate represented by the following formula (3) and a metal alcoholate represented by the following formula (4) in the presence of a reaction solvent, thereby producing a cyclic and/or linear phosphonitrilic acid ester represented by the following formula (5), characterized in that a metal arylolate and/or a metal alcoholate composed of at least two different metals having different ionization energies is used: 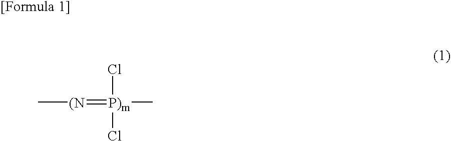
wherein m represents an integer of 3 or more; 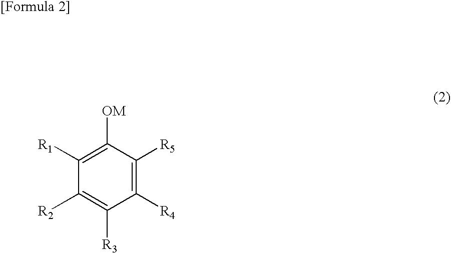
wherein M is an element selected from the group consisting of elements of group IA, IIA, IIIA, IVA, VA, VIA, IIB, IIIB, IVB, VB, VIIB, VIIB and VIII, R₁ to R₅ is a hydrogen atom, an OM group, an aliphatic hydrocarbon group having 1 to 10 carbon atoms or an aromatic hydrocarbon group having 6 to 10 carbon atoms, and R₁ and R₂, R₂ and R₃, R₃ and R₄, and R₄ and R₅ may form a ring; 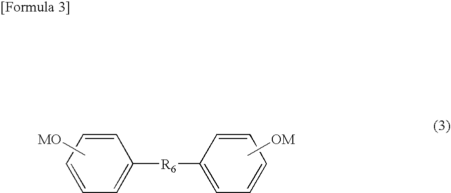
wherein M is an element selected from the group consisting of elements of group IA, IIA, IIIA, IVA, VA, VIA, IIB, IIIB, IVB, VB, VIIB, VIIB and VIII and R₆ is a single bond, an aliphatic hydrocarbon group having 1 to 10 carbon atoms or an aromatic hydrocarbon group having 6 to 10 carbon atoms;
[Formula 4]
R₇O-M (4)
wherein M is an element selected from the group consisting of elements of group IA, IIA, IIIA, IVA, VA, VIA, IIB, IIIB, IVB, VB, VIIB, VIIB and VIII and R₇ is an aliphatic hydrocarbon group having 1 to 10 carbon atoms; and 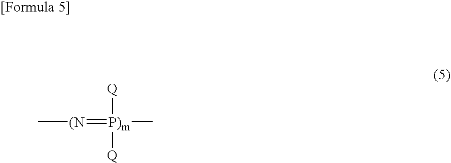
wherein Q represents an aryloxy group or an alkoxy group and m represents an integer of 3 or more.

2. The process for producing a phosphonitrilic acid ester according to claim 1, characterized in that a metal arylolate and/or a metal alcoholate composed of at least two different metals having different ionization energies is used and a compound represented by the following formula (6) is used as a catalyst when a cyclic and/or linear phosphonitrilic acid ester is produced:
[Formula 6]
(NH₄)ₚA_{q}Xᵣ (6)
wherein A is an element selected from the group consisting of elements of group IIA, IIIA, IVA, VA, VIA, IIB, IIIB, IVB, VB, VIIB, VIIB and VIII in the long form of periodic table, X represents a halogen atom, p is an integer of 9 to 10, q is an integer of 1 to 10 and r is an integer of 1 to 35.

3. The process for producing a phosphonitrilic acid ester according to claim 2, characterized in that the catalyst is represented by p=1 to 3 in the above formula (6).

4. The process for producing a phosphonitrilic acid ester according to claim 2, characterized in that A in the above formula (6) representing the catalyst is an element selected from the group consisting of Mg, Al, Cr, Co, Cu and Zn.

5. The process for producing a phosphonitrilic acid ester according to claim 2, characterized in that the catalyst is used in an amount of 10⁻⁵ to 1 mole per mole of phosphonitrile dichloride.

6. The process for producing a phosphonitrilic acid ester according to claim 1, characterized in that a metal arylolate and/or a metal alcoholate composed of at least two different metals having different ionization energies is used and an insoluble component in a reaction slurry obtained in preparation of phosphonitrile dichloride is used as a catalyst to produce a cyclic and/or linear phosphonitrilic acid ester.

7. The process for producing a phosphonitrilic acid ester according to claim 6, characterized in that the insoluble component in the reaction slurry is included in the reaction slurry formed after phosphorus chloride is reacted with ammonium chloride in the presence of a catalyst using phosphorus chloride and ammonium chloride when phosphonitrile dichloride is prepared.

8. The process for producing a phosphonitrilic acid ester according to claim 1, characterized in that the reaction solvent used for producing a phosphonitrilic acid ester is at least one selected from toluene, xylene, monochlorobenzene, dichlorobenzene and trichlorobenzene.

9. The process for producing a phosphonitrilic acid ester according to claim 1, characterized in that a metal having a higher ionization energy is used in an amount of 50% or less by mole based on the amount of a metal having a lower ionization energy.

10. The process for producing a phosphonitrilic acid ester according to claim 1, characterized in that metals in the metal arylolate and/or the metal alcoholate are at least two selected from the group consisting of Li, Na, K, Rb, Cs, Mg, Ca, Sr, Ba, Sc, Y, Ti, Zr, Hf, V, Nb, Cr, Mo, Al, Ga, In, Tl, La, Ce, Pr, Nd, Pm, Sm, Eu, Gd, Tb, Dy, Ho, Er, Tm, Yb and Lu.

11. The process for producing a phosphonitrilic acid ester according to claim 10, characterized in that one of the metal arylolate and/or metal alcoholate composed of at least two different metals having different ionization energies is sodium arylolate and/or sodium alcoholate and the other is at least one selected from potassium arylolate, potassium alcoholate, rubidium arylolate, rubidium alcoholate, cesium arylolate and cesium alcoholate.

12. The process for producing a phosphonitrilic acid ester according to claim 11, characterized in that 0.1 to 2.0 moles of the sodium arylolate and/or sodium alcoholate is used based on 1 mole of chloro groups in phosphonitrile dichloride.

13. The process for producing a phosphonitrilic acid ester according to claim 11, characterized in that 0.0001 to 1.0 mole of at least one selected from potassium arylolate, potassium alcoholate, rubidium arylolate, rubidium alcoholate, cesium arylolate and cesium alcoholate is used based on 1 mole of chloro groups in phosphonitrile dichloride.

14. The process for producing a phosphonitrilic acid according to claim 1, wherein the phosphonitrilic acid ester is cyclic and/or linear and represented by the formula (5), characterized by comprising the following two steps:
a first step of preparing phosphonitrile dichloride represented by the formula (1) by reacting phosphorus chloride and ammonium chloride in a halogenated aromatic hydrocarbon as a reaction solvent in the presence of a catalyst; and
a second step of producing the cyclic and/or linear phosphonitrilic acid ester represented by the formula (5) by reacting the phosphonitrile dichloride prepared in the first step with at least one selected from a metal arylolate represented by the formula (2), a metal arylolate represented by the formula (3) and a metal alcoholate represented by the formula (4) without isolating the phosphonitrile dichloride from the reaction slurry in the first step.

15. The process for producing a phosphonitrilic acid ester according to claim 14, characterized in that the catalyst used in the first step is at least one selected from metal oxides and metal chlorides.

16. The process for producing a phosphonitrilic acid ester according to claim 15, characterized in that the catalyst used in the first step is at least one selected from zinc oxide, magnesium oxide, aluminum oxide, cobalt oxide, copper oxide, zinc chloride, magnesium chloride, aluminum chloride, cobalt chloride, copper chloride and zinc chloride.

17. The process for producing a phosphonitrilic acid ester according to claim 14 to, characterized in that the halogenated aromatic hydrocarbon is at least one selected from monochlorobenzene, dichlorobenzene and trichlorobenzene.

18. The process for producing a phosphonitrilic acid ester according to claim 14, characterized in that the phosphonitrile dichloride used in the second step contains 1×10⁻⁶ mole or more of a metal derived from the catalyst from the first step based on 1 mole of phosphonitrile dichloride.

19. The process according to claim 1 for continuously producing a phosphonitrilic acid ester, characterized in that phosphonitrile dichloride and a metal arylolate and/or a metal alcoholate are continuously fed to a reactor individually or as a premix, and the resulting phosphonitrilic acid ester is continuously discharged out of the reactor from a place different from the feeding port(s) of phosphonitrile dichloride and the metal arylolate and/or metal alcoholate which are raw materials.

20. The process for producing a phosphonitrilic acid ester according to claim 1, characterized in that 0.5 mole or less of water is contained in the reaction system based on 1 mole of phosphonitrile dichloride when a cyclic and/or linear phosphonitrilic acid ester is produced from a cyclic and/or linear phosphonitrile dichloride.
